(19) United States
(12) Patent Application Publication
(10) Pub. No.: US 2014/0176676 A1
(43) Pub. Date: Jun. 26, 2014

(54) IMAGE INTERACTION SYSTEM, METHOD FOR DETECTING FINGER POSITION, STEREO DISPLAY SYSTEM AND CONTROL METHOD OF STEREO DISPLAY

(71) Applicant: Industrial Technology Research Institute, Hsinchu (TW)

(72) Inventors: Shang-Yi Lin, Taichung City (TW); Tien-You Lee, Hsinchu City (TW); Chia-Chen Chen, Hsinchu City (TW)

(73) Assignee: Industrial Technology Research Institue, Hsinchu (TW)

(21) Appl. No.: 14/040,735

(22) Filed: Sep. 30, 2013

(30) Foreign Application Priority Data
Dec. 22, 2012 (TW) 101149283
May 17, 2013 (TW) 102117572

(51) Int. Cl. H04N 13/04

(52) U.S. Cl. CPC H04N 13/0484
USPC 348/46

(57) ABSTRACT

The disclosure provides a stereo display system including a stereo display, a depth detector, and a computing processor. The stereo display displays a left eye image and a right eye image, such that a left eye and a right eye of a viewer generate a parallax to view a stereo image. The depth detector captures a depth data of a three-dimensional space. The computing processor controls image display of the stereo display. The computing processor analyzes an eyes position of the viewer according to the depth data, and when the viewer moves horizontally, vertically, or obliquely in the three-dimensional space relative to the stereo display, the computing processor adjusts the left eye image and the right eye image based on variations of the eyes position. Furthermore, an image interaction system, a method for detecting finger position, and a control method of stereo display are also provided.

### CROSS-REFERENCE TO RELATED APPLICATION

This application claims the priority benefits of Taiwan application serial no. 101149283, filed on Dec. 22, 2012, and Taiwan application serial no. 102117572, filed on May 17, 2013. The entirety of each of the above-mentioned patent applications is hereby incorporated by reference herein and made a part of specification.

### BACKGROUND

1. Technical Field

The disclosure relates to an image interaction system, a method for detecting a finger position, a stereo display system and a control method of a stereo display.

2. Related Art

In recent years, stereo displays have become one of the popular commodities in the consumer electronics market. Compared with the conventional flat panel displays, users can obtain different feelings by viewing stereo images.

For general stereo displays, stereo images viewed by viewers may change along with relative positions between the stereo displays and the viewers and the angles that the viewers view the stereo images. Accordingly, if the viewers desire to view better stereo images, they are limited to view the stereo images exactly in front of the stereo displays.

On the other hand, for some interactive stereo displays, users operate application programs by touching stereo images. However, similar to the limitation of the above stereo displays, the users are required to operate the application programs exactly in front of the stereo displays, so as to correctly perform the touch operation on the stereo images. If the users locate in other positions or view in different viewing angles, the viewed stereo images may be comparably different, and thus, the users can not correctly perform the touch operation on the stereo images.

### SUMMARY

The disclosure provides a stereo display system comprising a stereo display, a depth detector, and a computing processor. The stereo display is configured to display a left eye image and a right eye image, such that a left eye and a right eye of a viewer generate a parallax to view a stereo image. The depth detector is configured to capture a depth data of a three-dimensional space. The computing processor is coupled to the stereo display and the depth detector and configured to control image display of the stereo display. The computing processor analyzes an eyes position of the viewer according to the depth data, and when the viewer moves horizontally, vertically, or obliquely in the three-dimensional space relative to the stereo display, the computing processor adjusts the left eye image and the right eye image based on variations of the eyes position.

The disclosure provides a control method of a stereo display comprising the following steps: displaying a left eye image and a right eye image, such that a left eye and a right eye of a viewer generate a parallax to view a stereo image; capturing a depth data of a three-dimensional space; analyzing an eyes position of the viewer according to the depth data; and adjusting the left eye image and the right eye image based on variations of the eyes position when the viewer moves horizontally, vertically, or obliquely in the three-dimensional space relative to the stereo display.

The disclosure provides a stereo display system comprising a stereo display, a depth detector, and a computing processor. The stereo display is configured to display a left eye image and a right eye image, such that a left eye and a right eye of a viewer generate a parallax to view a stereo image. The depth detector is configured to capture a depth data of a three-dimensional space. The computing processor is coupled to the stereo display and the depth detector and configured to control image display of the stereo display. The computing processor analyzes an eyes position of the viewer according to the depth data and computes an appearance position of the stereo image appeared in the three-dimensional space according to the eyes position and a display position of the left eye image and the right eye image displayed in the stereo display. The computing processor performs the following steps: defining coordinates of a first vector, a second vector and a third vector in the three-dimensional space; computing a coordinate of the appearance position on the first vector according to a formula of

$${P}_{z} = \frac{{E}_{z} \times {D}_{obj} \times {W}_{dp}}{{D}_{obj} \times {W}_{dp} + {W}_{eye} \times {R}_{X}} ;$$

and computing the coordinate of the appearance position on the second vector and the third vector according to a formula of

$${P}_{x , y} = {E}_{x , y} + \frac{( {O}_{x , y} - {E}_{x , y} ) \times ( {E}_{z} - {P}_{z} )}{{E}_{z}} ,$$

where Pz is the coordinate of the appearance position on the first vector, Px,y is the coordinate of the appearance position on the second vector and the third vector, Ez is a coordinate of the left eye position or the right eye position on the first vector, Ex,y is a coordinate of the left eye position or the right eye position on the second vector and the third vector, Wdp is a width of a display region of the stereo display, Ox,y is a coordinate value of the left eye image or the right eye image on the second vector and the third vector, Weye is a distance between the left eye and the right eye, Dobj is a disparity between the left eye image and the right eye image, and Rx is a resolution of the stereo display on the second vector. Ox,y is corresponding to the left eye image when Ex,y and Ez are corresponding to the left eye position, and Ox,y is corresponding to the right eye image when Ex,y and Ez are corresponding to the right eye position. The computing processor adjusts the left eye image and the right eye image based on variations of the eyes position when the viewer moves in the three-dimensional space.

The disclosure provides a method for detecting a finger position, adapted to detect the finger position of a user. The method comprises the following steps: capturing an image data; obtaining a position of a hand region according to an image intensity information of the image data; dividing the hand region into a plurality of identification regions by at least one mask; and determining whether the identification regions satisfy with an identification condition to detect the finger position of the user.

The disclosure provides an image interaction system comprising a display, a video camera, and a computing processor. The display is configured to display an interactive image. The video camera configured to capture an image of a user to generate an image data. The computing processor is coupled to the display and the video camera and configured to control frame display of the display. The computing processor obtains a position of a hand region according to an image intensity information of the image data captured by the video camera, divides the hand region into a plurality of identification regions by at least one mask, and determines whether the identification regions satisfy with an identification condition to detect the finger position of the user.

In order to make the disclosure comprehensible, several exemplary embodiments accompanied with figures are described in detail below.

### BRIEF DESCRIPTION OF THE DRAWINGS

FIG. 1 is a schematic diagram illustrating a stereo display system according to an exemplary embodiment of the disclosure.

FIG. 2 is a schematic imaging diagram of the stereo display system according to an exemplary embodiment of the disclosure.

FIGS. 3A to 3E are schematic diagrams illustrating the adjustment of the left eye image and the right eye image based on the eyes position according to different embodiments of the disclosure.

FIG. 4 is a flow chart illustrating the control method of the stereo display according to an exemplary embodiment of the disclosure.

FIG. 5 is a flow chart illustrating the control method of the stereo display according to another exemplary embodiment of the disclosure.

FIGS. 6A to 6C are schematic diagrams illustrating the interaction operation of the stereo display system according to different embodiments of the disclosure.

FIG. 7A and FIG. 7B are schematic diagrams illustrating the stereo display system operated by using different specific touch media according to exemplary embodiments of the disclosure.

FIG. 8 is a schematic diagram of the preset templates according to an exemplary of the disclosure.

FIG. 9 is a schematic diagram illustrating the detection of the position of the finger according to an exemplary embodiment of the disclosure.

FIG. 10 is a flow chart illustrating the control method of the stereo display according to another exemplary embodiment of the disclosure.

FIG. 11 is a flow chart illustrating the method for determining whether the touch event occurs according to an exemplary embodiment of the disclosure.

FIG. 12 is a flow chart illustrating the method for determining whether the touch event occurs according to another exemplary embodiment of the disclosure.

FIG. 13 is a schematic diagram illustrating the image interaction system according to an exemplary embodiment of the disclosure.

FIG. 14 is a flow chart illustrating the method for detecting the finger position according to an exemplary embodiment of the disclosure.

FIG. 15 and FIG. 16 are schematic diagrams illustrating the detection of the finger position according to an exemplary embodiment of the disclosure.

FIG. 17 is a flow chart illustrating the method for detecting the finger position according to another exemplary embodiment of the disclosure.

FIG. 18A and FIG. 18B are schematic diagrams illustrating the method for analyzing the center position of the palm according to an exemplary embodiment of the disclosure.

FIG. 19 is schematic diagram illustrating the method for analyzing the fingertip position of the user according to an exemplary embodiment of the disclosure.

### DETAILED DESCRIPTION OF DISCLOSED EMBODIMENTS

In exemplary embodiments of the disclosure, a stereo display system and a control method of a stereo display are provided. The stereo display system and the control method of the stereo display are adapted to the stereo display designed based on any optical display principle. By this control method, a left eye image and a right eye image displayed by the stereo display are adaptively adjusted according to an eyes position of the viewer, such that a stereo image viewed by the viewer is displayed on a specific position, or a constant distance between the stereo image and the viewer is maintained based on the requirement of the viewer. Reference will now be made in detail to embodiments of the disclosure, examples of which are illustrated in the accompanying drawings.

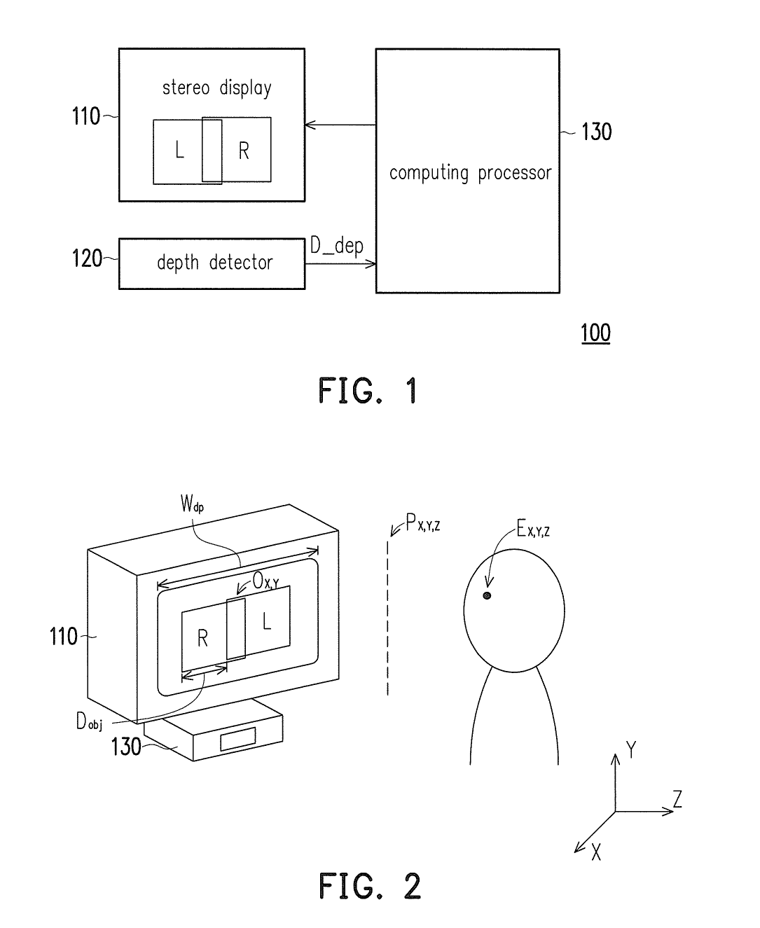

FIG. 1 is a schematic diagram illustrating a stereo display system according to an exemplary embodiment of the disclosure. Referring to FIG. 1, the stereo display system 100 comprises a stereo display 110, a depth detector 120 and a computing processor 130. In this embodiment, the stereo display 110 displays a left eye image L and a right eye image R respectively projected to a left eye and a right eye of a viewer in the display region of the stereo display 110. Accordingly, the viewer generates a parallax based on the images respectively received by the left eye and the right eye, so as to combine the images as a stereo image in the brain. Herein, based on different stereo display technologies, stereo displays are categorized into stereoscopic displays and auto-stereoscopic displays. However, the type of the stereo display 110 is not limited in the disclosure. Herein, the stereo image may be a flat image in a three-dimensional space or the stereo image having depths in the three-dimensional space.

The depth detector 120 is configured to capture a depth data D_dep of the three-dimensional space. Herein, the depth detector 120, for example, may be an active depth detector which actively emits lights or ultrasonic waves as signals to calculate the depth data D_dep, or a passive depth detector which calculates the depth data D_dep by using characteristic information in environments. The computing processor 130 is coupled to the stereo display 110 and the depth detector 120 and configured to control image display of the stereo display 110 according to the depth data D_dep.

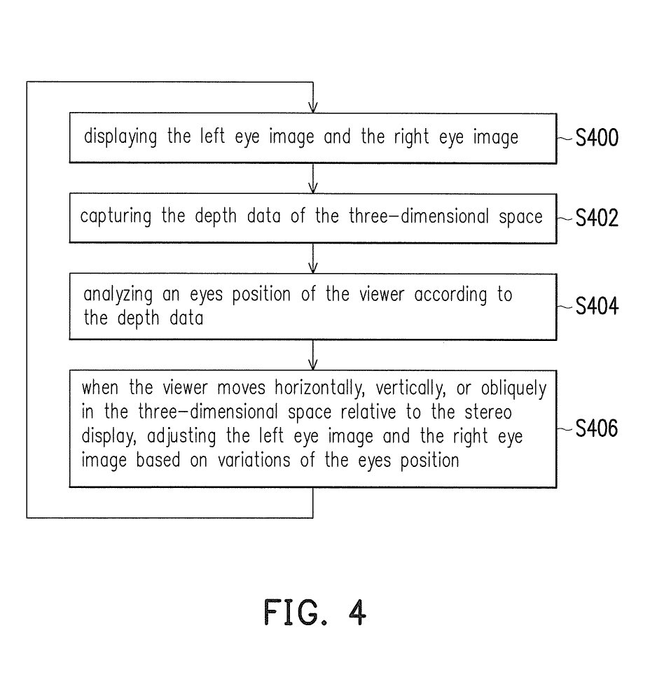

The control method of the stereo display 110 performed by the computing processor 130 is illustrated as FIG. 4, which is a flow chart illustrating the control method of the stereo display 110 according to an exemplary embodiment of the disclosure. Referring to FIG. 1 and FIG. 4, after the stereo display 110 displays the left eye image L and the right eye image R (step S400), the depth detector 120 captures the depth data D_dep of the three-dimensional space (step S402), and transmits the depth data D_dep to the computing processor 130. Accordingly, the computing processor 130 analyzes an eyes position of the viewer according to the received depth data D_dep (step S404). When the viewer moves horizontally, vertically, or obliquely in the three-dimensional space relative to the stereo display, the computing processor 130 adjusts the left eye image L and the right eye image R based on variations of the eyes position (step S406). Therefore, the computing processor 130 continuously follows the eyes position of the viewer according to the continuous depth data D_dep, and controls image display of the stereo display 110 according to the eyes position of the viewer, so as to dynamically adjust an appearance position of the stereo image appeared in the three-dimensional space according to the eyes position of the viewer.

Specifically, the appearance position of the viewed stereo image appeared in the three-dimensional space is affected by the eyes position of the viewer, the specification of the stereo display 110, such as the size of the display region and resolution, and the positions of the left eye image L and the right eye image R displayed on the stereo display 110. For example, under the condition that the left eye image L and the right eye image R are not changed, the stereo image viewed by the viewer exactly in front of the stereo display 110 is different from the stereo image viewed substantially in front of the stereo display 110 with a left or right offset.

In the present exemplary embodiment, the computing processor 130 adaptively adjusts the left eye image L and the right eye image R according to the eyes position of the viewer, so as to allow the appearance position of the stereo image changing along with the position and the view angle of the viewer, or allow the stereo image viewed by the viewer in any angle locating at a preset position in the three-dimensional space.

Furthermore, the step of analyzing the eyes position of the viewer according to the depth data D_dep (step S404), may be implemented by detecting the position of the head and then analyzing the eyes position according to the depth data D_dep through the computing processor 130.

For example, in an exemplary embodiment, the viewer defines an initial position in advance for viewing stereo images, such that the computing processor 130 is allowed to analyze the depth data D_dep for a preset region comprising the initial position. The computing processor 130 determines the characteristics of the head according to the depth data D_dep. For example, the computing processor 130 compares the depth data D_dep of the preset region to a hemisphere model. If a shape of an object corresponding to the depth data D_dep of the preset region satisfies with the hemisphere model, the computing processor 130 determines the position of the head of the viewer, and then analyzes the eyes position according to the ratio of the position of the head.

In another exemplary embodiment, the computing processor 130 may also actively detect the position of the head to confirm the eyes position of the viewer. For example, the computing processor 130 detects a dynamic motion, such as a wave, or a static posture, such as a specific gesture, and then analyzes the position of the head of the viewer according to regions of the detected dynamic motion or the static posture, so as to orientate and select a locating region comprising the position of the head. Accordingly, the computing processor 130 analyzes the depth data within the locating region to obtain the eyes position based on a method similar to the above method for analyzing the eyes position. Herein, the step of analyzing the eyes position of the viewer according to the depth data D_dep may be implemented in any of the above exemplary embodiments. However, the disclosure is not limited to the foregoing exemplary embodiments.

Furthermore, in the step of displaying the left eye image L and the right eye image R (step S400), to allow the viewer adapting to the viewed stereo image, when the disparity of the left eye image L and the right eye image R is set to a target value, the stereo display 110 is configured to gradually increase the disparity of the left eye image L and the right eye image R to the target value during an initial display period when the stereo display 110 initially displays the stereo image, such that the viewer views the stereo image gradually appears out of the stereo display 110.

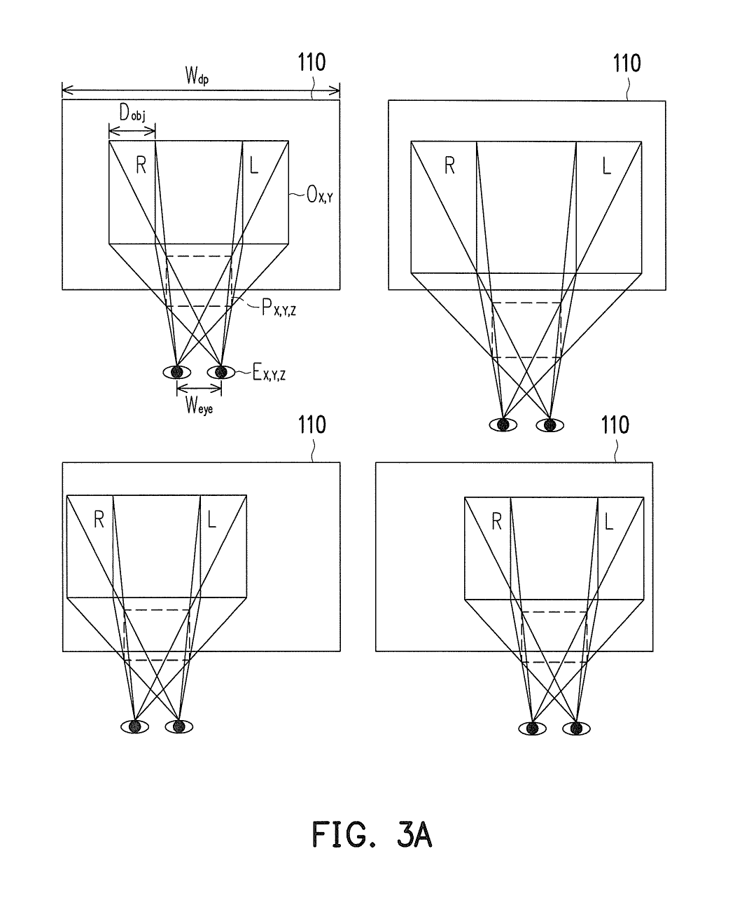

In order to further describe the stereo display system of the disclosure in detail, FIG. 2 is a schematic imaging diagram of the stereo display system according to an exemplary embodiment of the disclosure. In this embodiment, a display of screen type is exemplary for the stereo display 110, but the disclosure is not limited thereto. In other embodiments, the stereo display 110 may be implemented in the manner of projection. Furthermore, the computing processor 130 in FIG. 2 is disposed in the stereo display 110, but the disclosure is not limited thereto.

Referring to FIG. 1 and FIG. 2, the computing processor 130 defines coordinates of the three-dimensional space based on the captured depth data D_dep by the depth detector 120, and accordingly calculates a relative relationship of the appearance position of the stereo image and the eyes position of the viewer and the display position of the left eye image and the right eye image displayed in the stereo display 110.

Specifically, the computing processor 130 defines coordinates of a first vector z, a second vector x and a third vector y in the three-dimensional space so as to define the value of each pixel in the depth data D_dep as a corresponding coordinate position in the three-dimensional space. In the present embodiment, the computing processor 130 adopts the coordinate of the depth detector 120 as the origin of the coordinates of the first vector z, the second vector x and the third vector y for example, but the disclosure is not limited thereto.

In detail, the computing processor 130 computes the appearance position Px,y,z of the stereo image in the three-dimensional space according to the follow formulas:

$$\begin{matrix}{P}_{z} = \frac{{E}_{z} \times {D}_{obj} \times {W}_{dp}}{{D}_{obj} \times {W}_{dp} + {W}_{eye} \times {R}_{X}} & ( 1 ) \\ {P}_{x , y} = {E}_{x , y} + \frac{( {O}_{x , y} - {E}_{x , y} ) \times ( {E}_{z} - {P}_{z} )}{{E}_{z}} & ( 2 )\end{matrix}$$

wherein Pz is the coordinate of the appearance position on the first vector z, and Px,y is the coordinate of the appearance position on the second vector x and the third vector y. Ez is a coordinate of the left eye position or the right eye position on the first vector z, and Ex,y is a coordinate of the left eye position or the right eye position on the second vector x and the third vector y. Herein, Ez and Ex,y are combined as Ex,y,z to represent the coordinate of the left eye position or the right eye position in the three-dimensional space. Ox,y is a coordinate of the left eye image L or the right eye image R on the second vector x and the third vector y, i.e. the display position in the stereo display. Wdp is a width of a display region of the stereo display 110. Weye is a distance between the left eye and the right eye. Dobj is a disparity between the left eye image and the right eye image. Rx is a resolution of the stereo display 110 on the second vector x. When Ex,y and Ez are corresponding to the left eye position, Ox,y is corresponding to the left eye image, and when Ex,y and Ez are corresponding to the right eye position, Ox,y is corresponding to the right eye image.

In the present embodiment, since the coordinates of the left eye position and the right eye position can be converted based on the distance Weye between the left eye and the right eye, a person skilled in the art can conclude based on the teaching herein that no matter Ex,y,z represents the coordinate of the left eye position or the right eye position, the computing processor 130 can calculate the appearance position Px,y,z of the stereo image according to the above formulas (1) and (2).

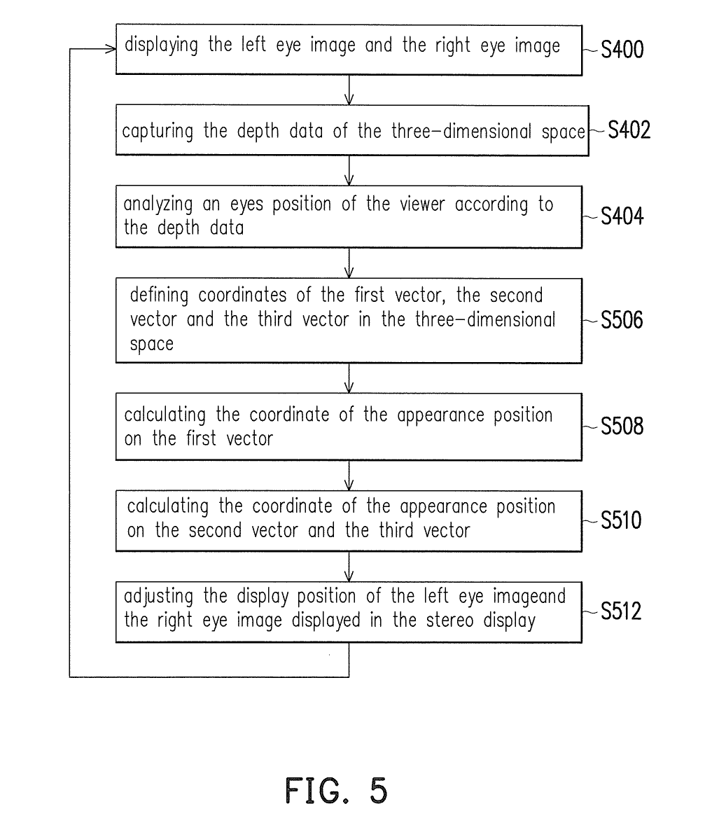

FIG. 5 is a flow chart illustrating the control method of the stereo display according to another exemplary embodiment of the disclosure. In the control method of this embodiment, the step of displaying the left eye image L and the right eye image R to the step of analyzing the eyes position of the viewer according to the depth data (step S400 to step S404) are similar to that of the foregoing embodiment of FIG. 4, and it will not be described again herein. Furthermore, for convenience, the left eye position and the left eye image L are exemplary for describing the teaching of calculating the appearance position in the present embodiment.

Referring to FIG. 1, FIG. 2 and FIG. 5, after the step of analyzing the eyes position of the viewer according to the depth data (step S404), the computing processor 130 defines coordinates of the first vector z, the second vector x and the third vector y in the three-dimensional space (step S506), and calculates formula (I) (step S508). In step S508, the disparity Dobj between the left eye image L and the right eye image R is obtained based on positions of the left eye image L and the right eye image R before adjustment. The width Wdp of the display region and the resolution Rx of the stereo display 110 are known preset specifications. The left eye position Ex,y,z and the distance Weye between the left eye and the right eye are obtained by analyzing the depth data D_dep. Moreover, since the distance between the left eye and the right eye are similar for most people, the distance Weye may also be preset in the computing processor 130 in advance. Accordingly, the computing processor 130 calculates the coordinate Pz of the appearance position on the first vector z.

Next, the computing processor 130 calculates formula (2) (step S510). In step S510, the coordinate Ox,y of the left eye image L is obtained based on the left eye image L before adjustment. The coordinate Pz of the appearance position on the first vector z is obtained based on the previous step S508. Accordingly, the computing processor 130 calculates the coordinate Px,y of the appearance position on the second vector x and the third vector y. Based on the steps S508 and S510, the computing processor 130 obtains the coordinate Px,y,z of the appearance position in the three-dimensional space.

Accordingly, the computing processor 130 adjusts the display position of the left eye image L and the right eye image R displayed in the stereo display 110 based on the coordinate Ex,y,z of the left eye position or the right eye position (step S512), such that the stereo image appears in different positions in the three-dimensional space according to the design requirement. In detail, based on formulas (1) and (2), in step S512, the step of adjusting the display position of the left eye image L and the right eye image R displayed in the stereo display 110 is implemented by adjusting the coordinate Ox,y of the left eye image L and the disparity Dobj.

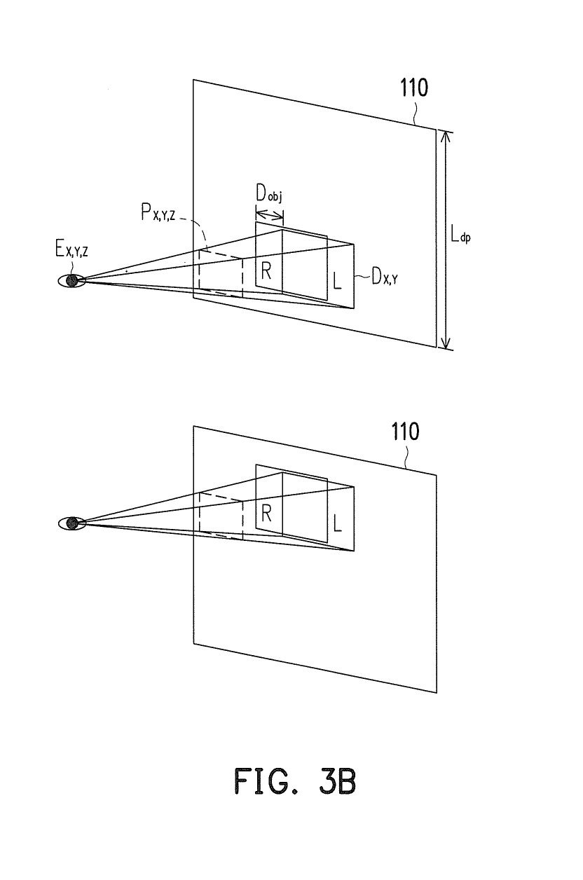

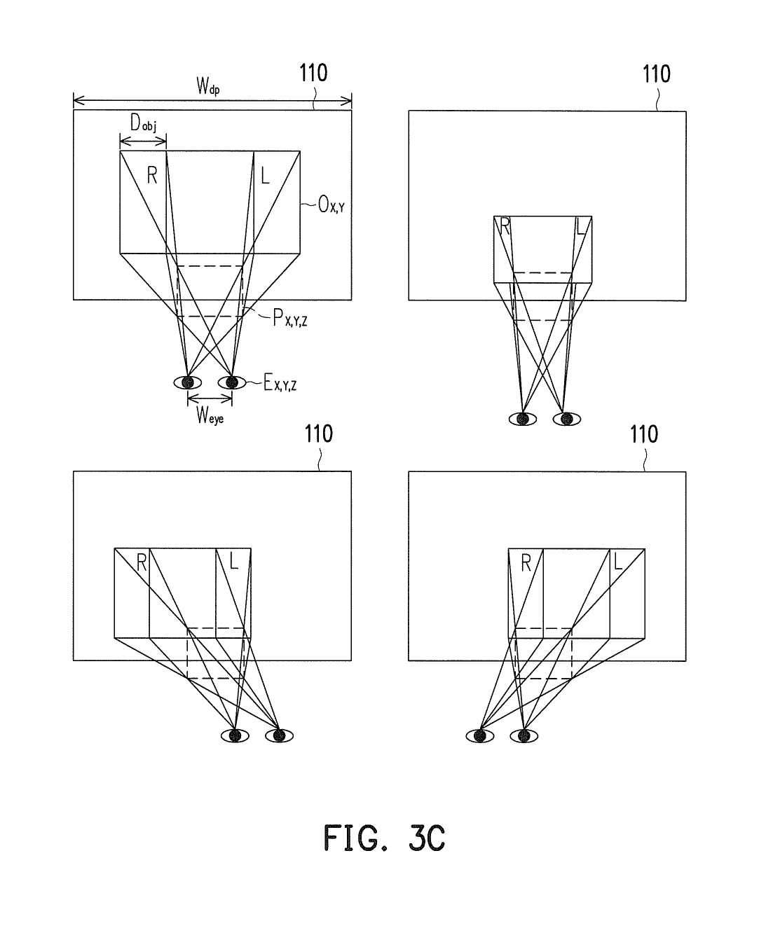

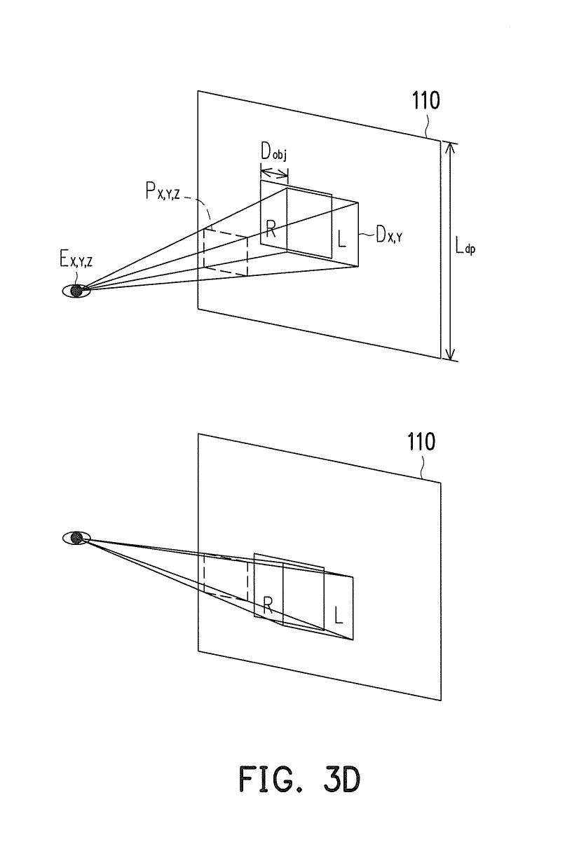

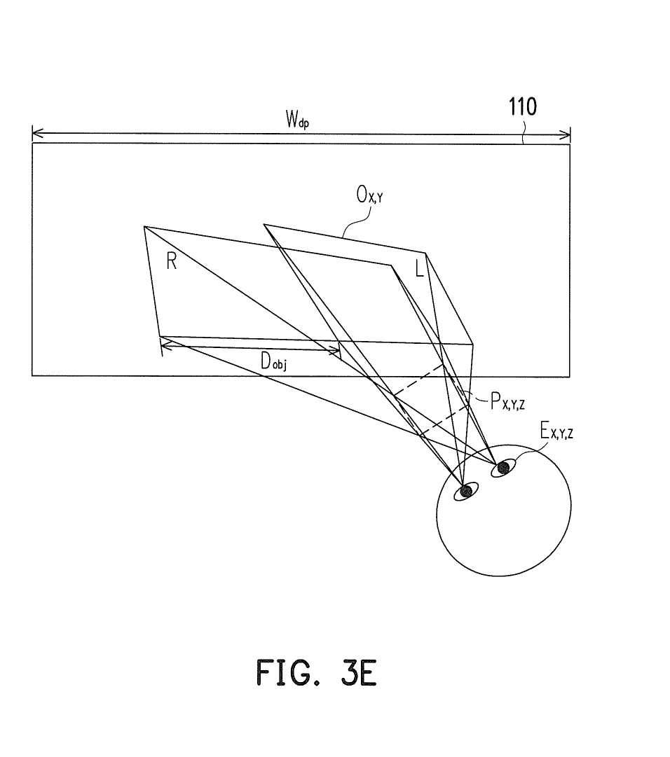

As shown in FIGS. 3A to 3E, the appearance position of the stereo image is designed to move with the position of the viewer, be fixed on a preset position, change with the view angle of the viewer, and so on based on the design requirement. Herein, FIGS. 3A to 3E are schematic diagrams illustrating the adjustment of the left eye image and the right eye image based on the eyes position according to different embodiments of the disclosure.

First, referring to FIG. 1 and FIG. 3A, in the present embodiment, the appearance position Px,y,z of the stereo image is set to have a constant distance away from the eyes position Ex,y,z of the viewer. As shown in FIG. 3A, when the computing processor 130 detects that the viewer approaches the stereo display 110, the computing processor 130 adjusts the coordinate Ox,y of the left eye image L and the right eye image R and the disparity Dobj, such that the display region of the left eye image L and the right eye image R displayed in the stereo display 110 decreases. On the contrary, when the viewer leaves the stereo display 110, the computing processor 130 adjusts the coordinate Ox,y of the left eye image L and the right eye image R and the disparity Dobj, such that the display region of the left eye image L and the right eye image R displayed in the stereo display 110 increases. Accordingly, no matter the viewer approaches or leaves the stereo display 110, the distance between the appearance position Px,y,z and the eyes position Ex,y,z is maintained constant.

On the other hand, when the viewer moves left or right relative to the stereo display 110, as shown in FIG. 3A, the computing processor 130 adjusts the coordinate Ox,y of the left eye image L and the right eye image R and the disparity Dobj, such that the display position of the left eye image L and the right eye image R displayed in the stereo display 110 moves left or right corresponding to the eyes position Ex,y,z. Accordingly, no matter moving left or right, the viewer views that the stereo image is continuously maintained in the front of the eyes position Ex,y,z.

Furthermore, referring to FIG. 1 and FIG. 3B, when the viewer stays in different height, or does some actions, such as jump, sitting and squat, and thus moves relative to the stereo display 110 in the vertical direction (that is the coordinate of the eyes position Ex,y,z on the first vector z has changed), the computing processor 130 adjusts the coordinate Ox,y of the left eye image L and the right eye image R and the disparity Dobj, such that the display position of the left eye image L and the right eye image R displayed in the stereo display 110 moves up or down, i.e. moves along the z axis, corresponding to the eyes position Ex,y,z. Accordingly, the viewer still views that the stereo image is continuously maintained in the front of the eyes position Ex,y,z when moving up or down.

In the present embodiment, when the viewer leaves the stereo display 110 farther, the display region of the left eye image L and the right eye image R displayed in the stereo display 110 is required to become larger. When the viewer moves left and right or moves up and down relative to the stereo display 110, the display region of the left eye image L and the right eye image R is respectively limited to the width Wdp and the length Ldp of the display region of the stereo display 110. In other words, the maximum display region of the stereo image viewed by the viewer changes based on the size of the display region of the stereo display 110. In detail, according to the size of the display region of the stereo display 110, the intersection of the maximum regions that the left eye image L and the right eye image R are respectively displayed in the stereo display 110, such as the whole display region, is the maximum display region of the stereo image viewed by the viewer.

Referring to FIG. 1 and FIG. 3C, in the present embodiment, the appearance position Px,y,z of the stereo image is set to be fixed on a preset position in the three-dimensional space. That is, no matter how the viewer moves, the viewer views that the appearance position Px,y,z is maintained constant. As shown in FIG. 3C, when the computing processor 130 detects that the viewer approaches the stereo display 110, the computing processor 130 adjusts the coordinate Ox,y of the left eye image L and the right eye image R and the disparity Dobj, such that the display region of the left eye image L and the right eye image R displayed in the stereo display 110 increases. On the contrary, when the viewer leaves the stereo display 110, the computing processor 130 adjusts the coordinate Ox,y of the left eye image L and the right eye image R and the disparity Dobj, such that the display region of the left eye image L and the right eye image R displayed in the stereo display 110 decreases. In other words, the computing processor 130 adjusts the coordinate Ox,y of the left eye image L and the right eye image R and the disparity Dobj to balance the change of the appearance position Px,y,z due to the variations of the eyes position. Accordingly, no matter the viewer approaches or leaves the stereo display 110, the appearance position Px,y,z is maintained in the preset position in the three-dimensional space.

On the other hand, as shown in FIG. 3C, when the viewer moves left relative to the stereo display 110, the computing processor 130 adjusts the coordinate Ox,y of the left eye image L and the right eye image R and the disparity Dobj, such that the display position of the left eye image L and the right eye image R correspondingly moves right in the display region. On the contrary, when the viewer moves right relative to the stereo display 110, the computing processor 130 adjusts the coordinate Ox,y of the left eye image L and the right eye image R and the disparity Dobj, such that the display position of the left eye image L and the right eye image R correspondingly moves left in the display region. Accordingly, the viewer views that the stereo image is maintained at the preset position in the three-dimensional space.

In addition, referring to FIG. 1 and FIG. 3D, when the viewer moves down relative to the stereo display 110, and thus the viewing height decreases, the computing processor 130 adjusts the coordinate Ox,y of the left eye image L and the right eye image R and the disparity Dobj, such that the display position of the left eye image L and the right eye image R correspondingly moves up in the display region. On the contrary, when the viewer moves up relative to the stereo display 110, and thus the viewing height increases, the computing processor 130 adjusts the coordinate Ox,y of the left eye image L and the right eye image R and the disparity Dobj, such that the display position of the left eye image L and the right eye image R correspondingly moves down in the display region. Accordingly, the viewer views that the stereo image is maintained at the preset position in the three-dimensional space.

Furthermore, the appearance position Px,y,z of the stereo image of the present embodiment is similar to that of the embodiment of FIG. 3, the maximum display region also changes based on the size of the display region of the stereo display 110.

Referring to FIG. 1 and FIG. 3E, in the present embodiment, the appearance position Px,y,z of the stereo image is further adjusted along with the viewing angle of the viewer. As shown in FIG. 3C, when the viewer moves obliquely relative to the stereo display, the computing processor detects the eyes position Ex,y,z is not parallel to the stereo display 110, i.e. the viewer does not exactly face the display region of the stereo display 110. The computing processor 130 adjusts the coordinate Ox,y of the left eye image L and the right eye image R and the disparity Dobj, such that the left eye image L and the right eye image R are correspondingly adjusted, and thus the stereo image changes direction along with the viewing angle of the viewer. Accordingly, the viewer views that the stereo image changes direction along with the viewing angle of the viewer and faces the viewing directions of the viewer, i.e. the viewing directions of the viewer are orthogonal on a plane of the dotted rectangle representing the appearance position Px,y,z of the stereo image. Herein, the control method of the stereo display disclosed in this embodiment may be implemented by combining the embodiments of FIG. 3A to FIG. 3D. Alternatively, each of the embodiments of FIG. 3A to FIG. 3D may be independently implemented in the stereo display system 100. The disclosure is not limited thereto.

Herein, the disclosed formulas is simply exemplary for teaching an implementation of an embodiment and do not limit the disclosure. If the stereo image viewed by the viewer changes along with the viewing angle, and the appearance position and the angle are adaptively adjusted in a control method of a stereo display and a stereo display system, the control method of the stereo display and the stereo display system do not depart from the scope or spirit of the disclosure.

Referring to FIG. 1, since the stereo display system 100 detects the object in the three-dimensional space by using the depth detector 120, the stereo display system 100 may further serve as a stereo display system that the viewer can interact with the stereo image in another embodiment.

Specifically, besides adjusting the appearance position of the stereo image according to the eyes position of the viewer, the computing processor 130 may also detect a touch event that the viewer touches the stereo image and control image display of the stereo display 110 according to the detected touch event, so as to implement the interaction function of the stereo image in the three-dimensional space.

Since the appearance position of the stereo image is adaptively adjusted based on the position of the user in the stereo display system 100, when the user would like to interact with the stereo image, the user touches the appearance position of the stereo image more conveniently. For example, as the description of the embodiment of FIG. 3A, if the appearance position of the stereo image in the three-dimensional space is maintained to have a constant distance away from the user, the user is not required to stand exactly in front of the stereo display 110 while touching the stereo image.

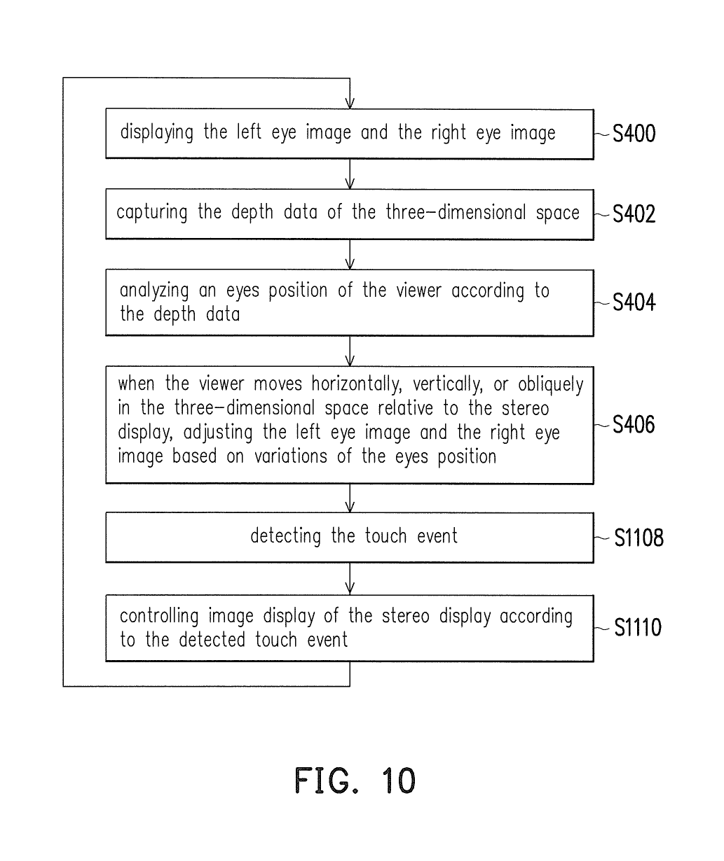

FIG. 10 is a flow chart illustrating the control method of the stereo display according to another exemplary embodiment of the disclosure. In the control method of this embodiment, the step of displaying the left eye image L and the right eye image R to the step of analyzing the eyes position of the viewer according to the depth data (step S400 to step S404) are similar to that of the foregoing embodiment of FIG. 4, and it will not be described again herein.

Referring to FIG. 1 and FIG. 10, after the step of adjusting the left eye image L and the right eye image R (step S406), the computing processor 130 detects a touch event (step S1108), and controls image display of the stereo display 110 according to the detected touch event (step S1110).

Specifically, in step S1108, the computing processor 130 analyzes the position of the touch media in the three-dimensional space based on the depth data, and determines whether the touch event occurs based on the appearance position of the stereo image and the position of the touch media. When the computing processor 130 determines the touch event occurs, the computing processor 130 controls the stereo display 110 based on the type of the corresponding application program and the type of the detected touch event. When the computing processor 130 determines the touch event does not occur, the computing processor 130 returns to step S400 to perform the step flow of FIG. 10 again.

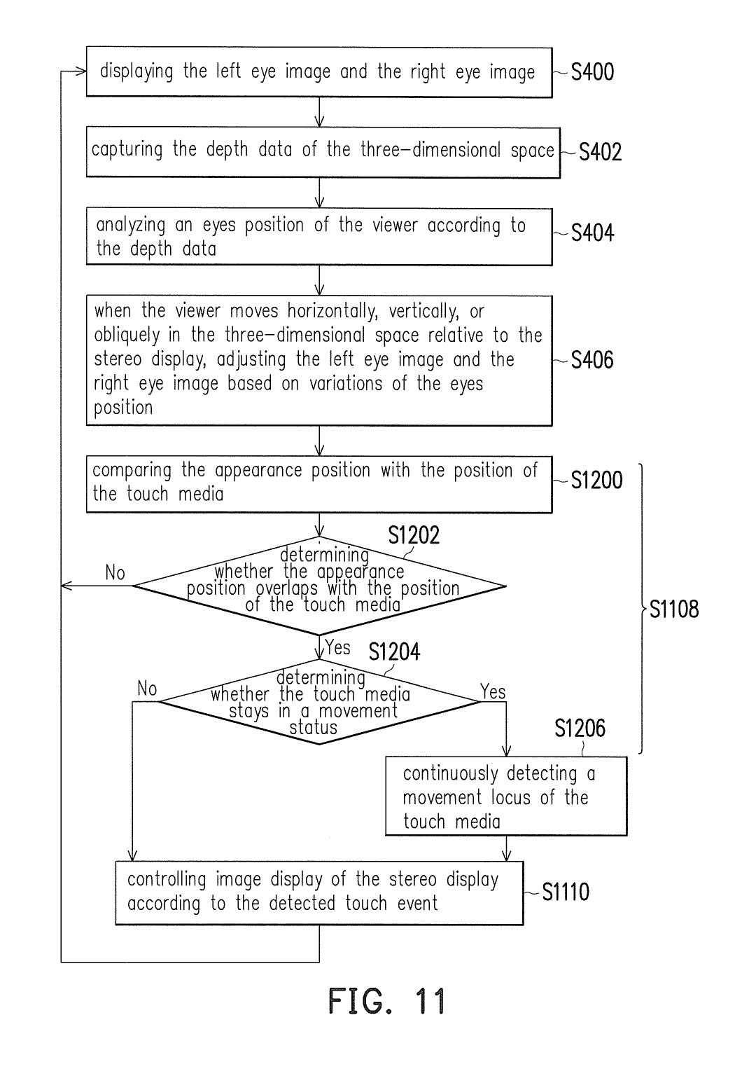

FIG. 11 is a flow chart illustrating the method for determining whether the touch event occurs according to an exemplary embodiment of the disclosure. Referring to FIG. 1 and FIG. 11, in the step of detecting the touch event (step S1108), the computing processor 130 compares the appearance position of the stereo image with the position of the touch media (step S1200), and determines whether the appearance position overlaps with the position of the touch media (step S1202). When the computing processor 130 determines the stereo image is not touched by the user, i.e. the touch event does not occurs, the computing processor 130 returns to perform step S400. On the other hand, when the computing processor 130 determines the appearance position overlaps with the position of the touch media, the computing processor 130 determines the stereo image is touched by the user, i.e. the touch event occurs.

After the computing processor 130 determines the touch event occurs, the computing processor 130 determines whether the touch media stays in a movement status (step S1204). If the computing processor 130 determines the touch media does not move or immediately leaves the stereo image after touching the stereo image, i.e. the position of the touch media does not overlap with the appearance position, the computing processor 130, for example, determines the user touches the stereo image in the manner of clicking, so as to controls image display of the stereo display 110 based on the touch position and the application program.

On the other hand, if the computing processor 130 determines the touch media stays in the movement status, the computing processor continuously detects a movement locus of the touch media (step S1206), and controls image display of the stereo display 110 according to the movement locus and the corresponding application program.

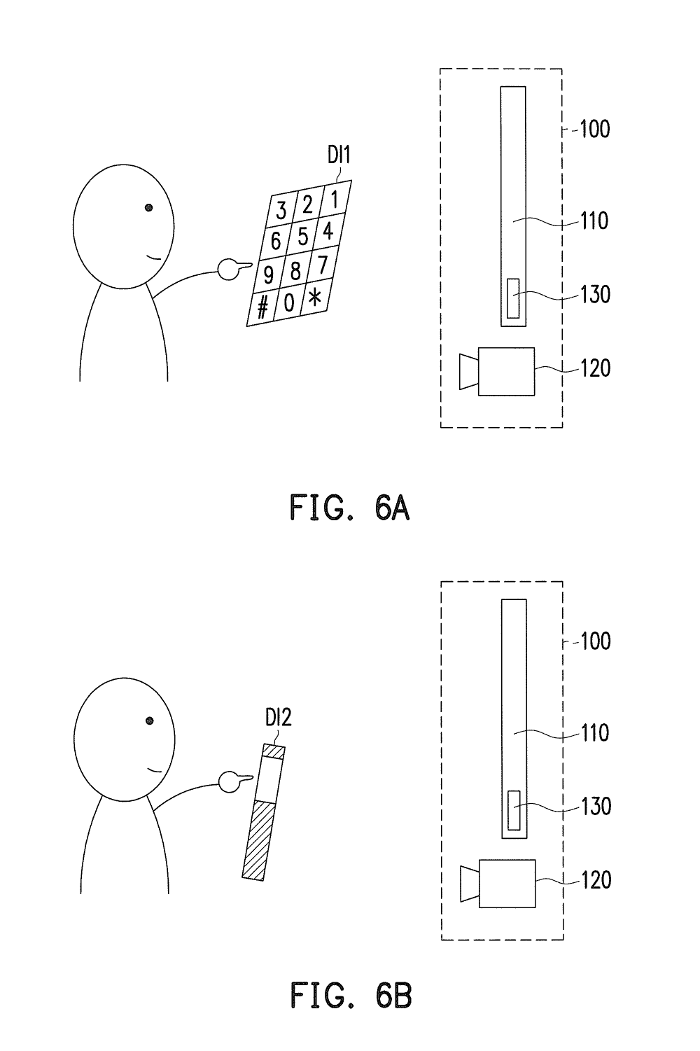

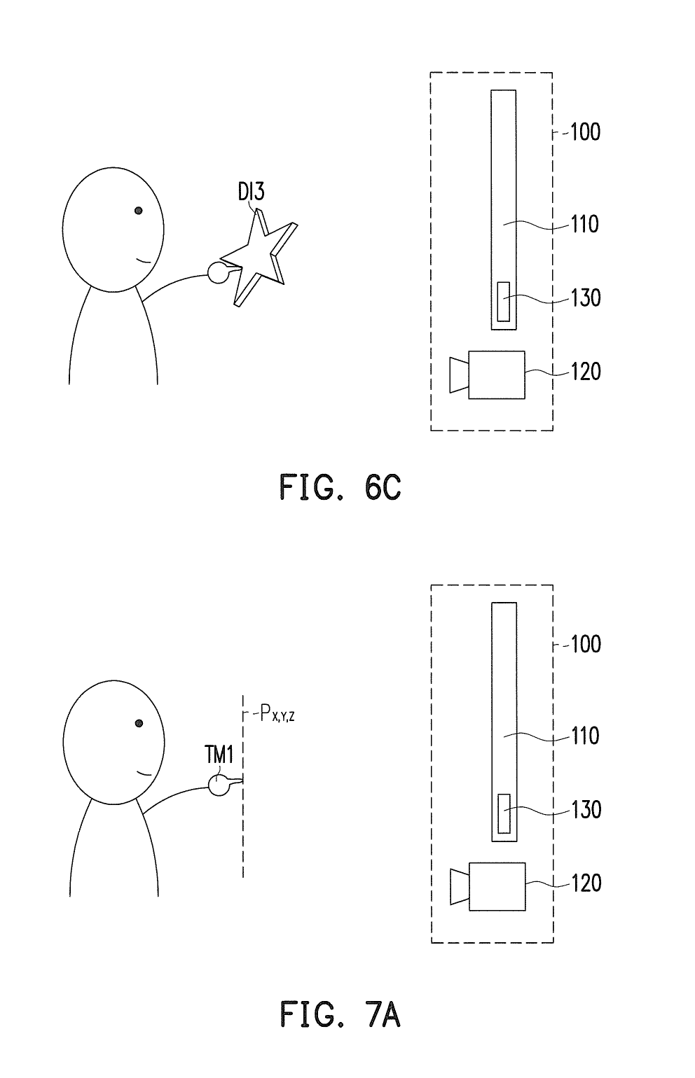

For example, the user operates the stereo images which are represented by different application program interfaces in different touch methods as shown in FIGS. 6A to 6C. FIGS. 6A to 6C are schematic diagrams illustrating the interaction operation of the stereo display system according to different embodiments of the disclosure. Herein, FIGS. 6A to 6C respectively show the user operates the application program interfaces of the menu DI1, the scroll bar DI2, and the stereo object DI3.

Referring to FIG. 6A, when the stereo image viewed by the user is the application program interface of the menu DI1, the user touches the appearance position of the stereo image by clicking, such that the computing processor 130 controls a corresponding item on the menu DI1 to be triggered in response to the touch of the user, and accordingly controls the stereo display 110 to display the corresponding image. Furthermore, the user may also drag the menu DI1 to allow the appearance position of the menu DI1 moving along with the movement locus of the user's touch.

Referring to FIG. 6B, when the stereo image viewed by the user is the application program interface of the scroll bar DI2, the user drags the scroll bar DI2, such that the computing processor 130 controls the scroll bar DI2 to scroll with the movement locus in response to the movement locus of the user's touch.

Referring to FIG. 6C, when the stereo image viewed by the user is the application program interface of the stereo object DI3 having depth, the user drags the stereo object DI3, such that the stereo object DI3 rotates or moves according to the movement locus of the user's touch to show the stereo object DI3 viewed in different angles. Alternatively, the user may also select different parts of the stereo object DI3 by clicking.

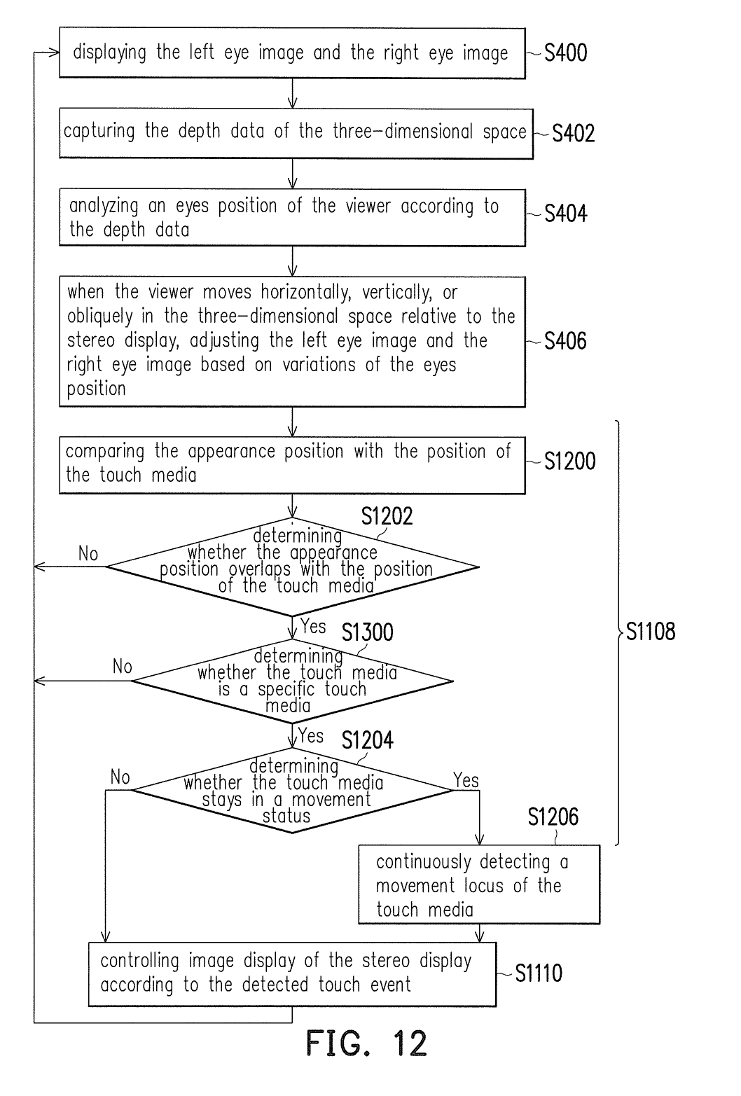

Generally speaking, when the user interacts with the stereo display system 100, the user may touch the stereo image by using different touch media. However, the stereo display system 100 may also be limited to be operated by using a specific touch media, and the control method thereof is shown in FIG. 12. Herein, FIG. 12 is a flow chart illustrating the method for determining whether the touch event occurs according to another exemplary embodiment of the disclosure.

Referring to FIG. 1 and FIG. 12, in this embodiment, the step flow is similar to that of the foregoing embodiment of FIG. 11, and the similar steps will not be described again herein. Specifically, the difference therebetween lies in that after the computing processor 130 determines whether the appearance position overlaps with the position of the touch media (step S1202), the computing processor 130 further determines whether the touch media is a specific touch media (step S1300). When the computing processor 130 determines the touch media overlapping with the appearance position is the specific touch media, the computing processor 130 determines the touch event occurs, and then continuously performs the step S1204. On the contrary, when the computing processor 130 determines the touch media overlapping with the appearance position is not the specific touch media, the computing processor 130 determines the touch event does not occur, and then return to perform the step S400.

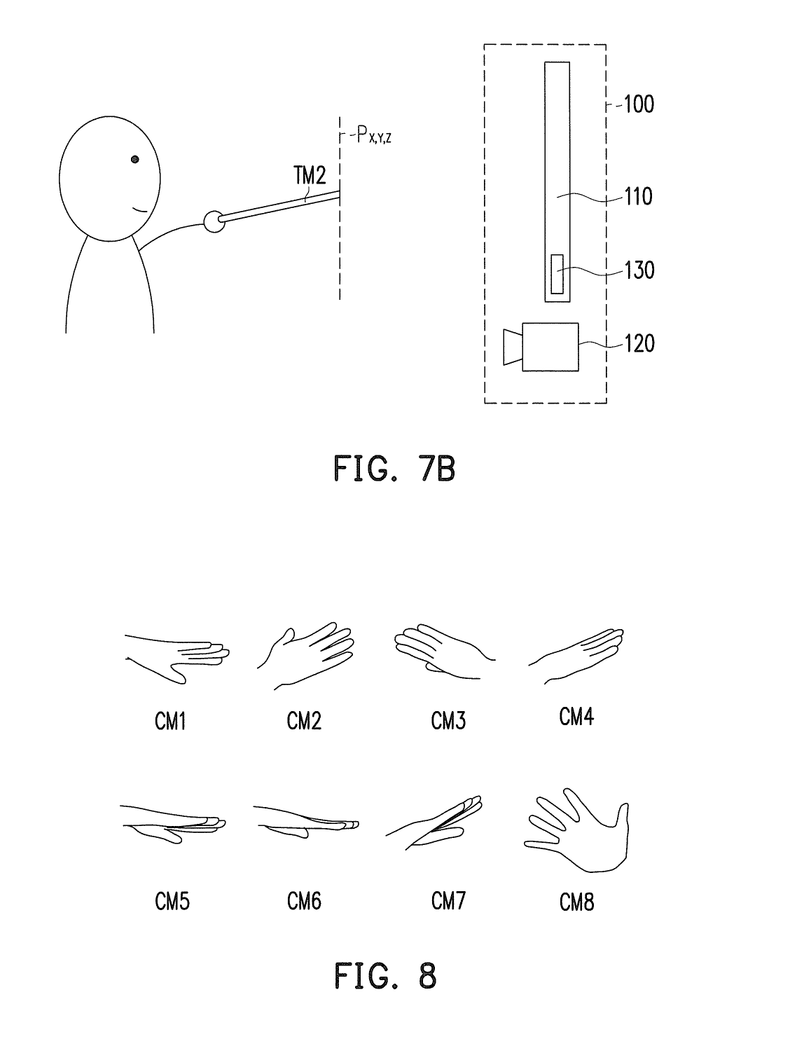

For example, FIG. 7A and FIG. 7B are schematic diagrams illustrating the stereo display system operated by using different specific touch media according to exemplary embodiments of the disclosure. Herein, FIG. 7A and FIG. 7B respectively show operating conditions that a finger TM1 and a touch stick TM2 serve as touch media. Referring to FIG. 7A and FIG. 7B, when the specific touch media is set as the finger TM1, the computing processor 130 determines whether the touch is effective based on whether the specific touch media is the finger TM1. Accordingly, the computing processor 130 simply determines the operating condition shown in FIG. 7A is an effective touch and determines the touch event occurs. The operation of the user touching the appearance position Px,y,z of the stereo image by using the touch stick TM2 in FIG. 7B is deemed as an ineffective touch. On the contrary, when the specific touch media is set as the touch stick TM2, the computing processor 130 determines whether the touch is effective based on whether the specific touch media is the touch stick TM2.

Besides the finger and the touch stick mentioned above, the computing processor 130 may determine the specific touch media based on a specific shape of an object, such as a palm of a hand, a gesture, a posture of a body, a star-like object or a circular object. Furthermore, the specific touch media is not limited to a static posture, the dynamic motion of the user may also serve as the specific touch media, such as the dynamic motion of waving or brandishing an object.

Specifically, the computing processor 130 may identify whether the touch media is a specific touch media based on multiple different methods. For example, the computing processor 130 identifies whether the touch media is a specific touch media by comparing the touch media with preset templates. Taking different gestures serving as the specific touch media for example, the preset templates may be shown in FIG. 8. FIG. 8 is a schematic diagram of the preset templates according to an exemplary of the disclosure.

Referring to FIG. 1 and FIG. 8, when the user touches the stereo image, the computing processor 130 determines whether the touch media that the user uses to touch the stereo image satisfies with preset templates CM1 to CM8. When the computing processor 130 detects the type of the touch media satisfies with one of the preset templates CM1 to CM8, the computing processor 130 controls image display of the stereo display 110 in response to the touch operation. Besides, similar to the method of comparing the touch media with preset templates CM1 to CM8, the computing processor 130 may also identify whether the touch media is a specific touch media by comparing the touch media with a preset dynamic motion.

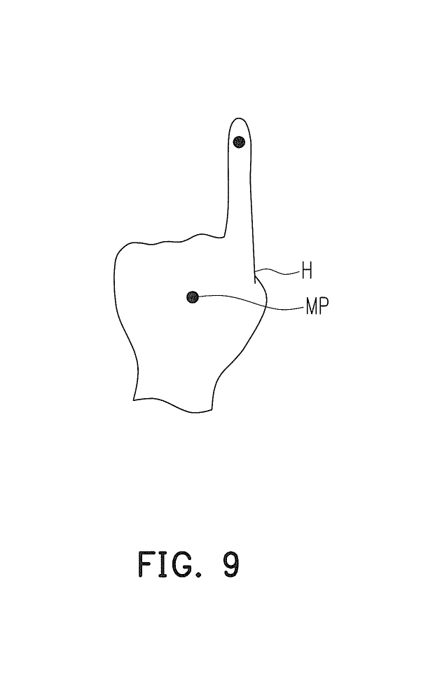

For example, when the touch media is preset as a finger, the computing processor 130 analyzes a position of the finger according to a hand outline, as shown in FIG. 9. FIG. 9 is a schematic diagram illustrating the detection of the position of the finger according to an exemplary embodiment of the disclosure.

Referring to FIG. 1 and FIG. 9, when the specific touch media preset in the computing processor 130 is the finger of the user, the computing processor 130 may calculate a curvature of a center position MP of a palm and a point coordinate on the hand outline H, and determines whether a distance of the point coordinate on the hand outline H and the center position of the palm is much larger than an average distance of each point coordinate on the hand outline H and the center position MP. When the distance of the point coordinate on the hand outline H and the center position MP of the palm is much larger than an average distance of each point coordinate on the hand outline H and the center position MP, and the curvature of the point coordinate is large enough, the computing processor 130 determines the point coordinate on the hand outline H is the position of the finger. For example, in one exemplary embodiment, the computing processor 130 may compare the calculated curvature to a threshold value, and when the computing processor 130 determines the calculated curvature is larger than the threshold value, the computing processor 130 determines the point coordinate on the hand outline H is the position of the finger. Herein, the threshold value is set based on the design requirement, and the disclosure is not limited thereto.

Accordingly, the computing processor 130 may determine whether the fingertip coordinate overlaps with the coordinate of the appearance position to determine whether the stereo image is touched by the user based on a method similar to the description of the above-mentioned embodiment.

Based on the above description, the stereo display system 100 provides a human-computer interaction interface by detecting whether the position of the touch media overlaps with the appearance position of the stereo image. According to this stereo image display method, the user is not required and limited to operate the human-computer interaction exactly in front of the stereo display, and thus the user may feel good stereo touch experience.

In another exemplary embodiment of the disclosure, a method for detecting a finger position and an image interaction system are provided, which are adapted to the display designed based on any optical display principle. In the image interaction system, the image displayed in the display is adjusted according to variation of the position of the finger and the palm of the user, such that the user gives different instructions to the image interaction system according to different gestures. The image interaction system and the method for detecting the finger position are further described in the following exemplary embodiments.

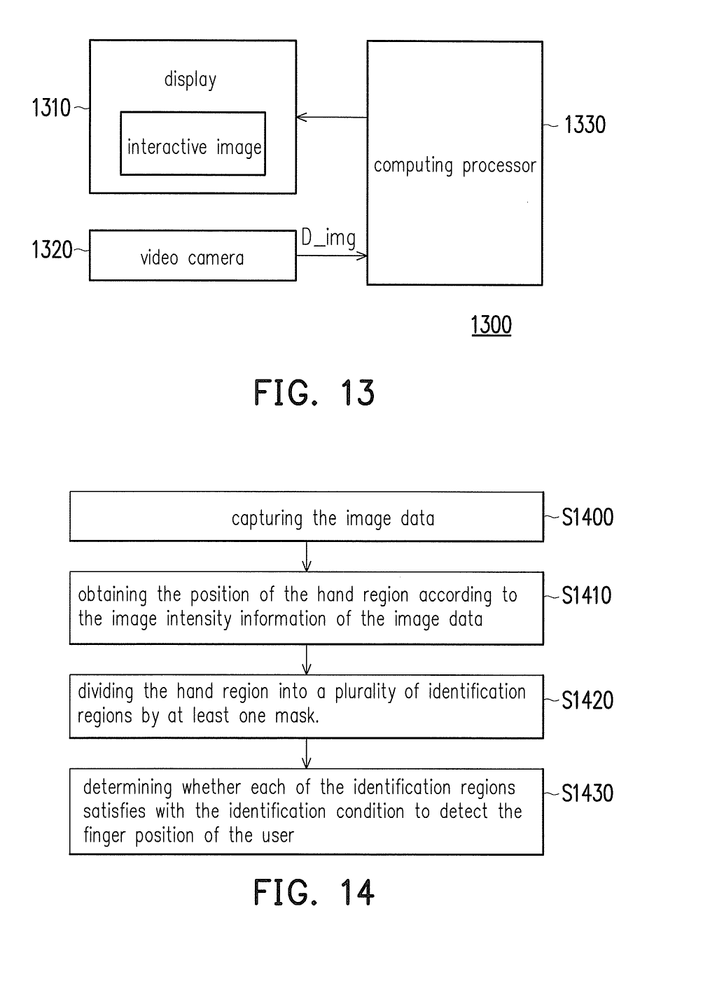

FIG. 13 is a schematic diagram illustrating the image interaction system according to an exemplary embodiment of the disclosure. Referring to FIG. 13, the image interaction system 1300 comprises a display 1310, a video camera 1320 and a computing processor 1330.

In the present embodiment, the display 1310 displays an interactive image IMG for the user to perform an interactive operation in a display region thereof. The video camera 1320 is configured to capture the image of the user to generate an image data D_img. After the image data D_img is processed by the computing processor 1330, the position of the palm and the finger of the user in the image is obtained. Accordingly, the user performs an operation on the interactive image IMG based on the action of the hand. Herein, according to different used apparatuses, the display 1310 may be a flat panel display or a stereo display, and the stereo display may be a stereoscopic display or an auto-stereoscopic display. The video camera 1320, for example, may be a video camera for detecting brightness, such as a visible light camera, a video camera for detecting chroma, such as a chroma detector, or the depth detector of the above embodiment. The disclosure does not limit the types of the display 1310 and the video camera 1320.

Furthermore, the method for analyzing the position of the palm and the finger of the user by using the computing processor 1330 is as shown in FIG. 14. FIG. 14 is a flow chart illustrating the method for detecting the finger position according to an exemplary embodiment of the disclosure. Referring to FIG. 13 and FIG. 14, the computing processor 1330 captures the image data of the user from the video camera 1320 (step S1400) and obtains the position of the hand region of the user according to an image intensity information of the captured image data (step S1410). Next, the computing processor 1330 divides the hand region into a plurality of identification regions by a predefined mask (step S1420) and determines whether the identification regions satisfy with a preset identification condition to detect the finger position of the user (step S1430). In the present embodiment, the image intensity information is different types of information based on the types of the video camera 1320. For example, if the video camera 1320 is a monochrome video camera which captures grayscale images, the image intensity information is the grayscale information of the image data D_img. If the video camera 1320 is a chroma detector which captures image chroma, the image intensity information is the chroma information of the image data D_img. If the video camera 1320 is a depth detector, the image intensity information is the depth data. However, the disclosure is not limited thereto.

In an exemplary embodiment, after capturing the image data of the user from the video camera 1320, the computing processor 1330 calculates an image intensity distribution, such as a color distribution of the hand, based on the image intensity information of the image data D_img, and defines a region of the image data locating in hand image intensity information range, such as the maximum region satisfying with the color distribution of the hand in the image data D_img, as the hand region of the user by comparing the image intensity distribution to the hand image intensity information range. In other words, in the present exemplary embodiment, the computing processor 1330 detects the position of the hand region by calculating the difference of the pixel values between the skin color and the background color. For example, the calculation result, such as the color distribution of the hand disclosed, in the present exemplary embodiment may be calculated based on the following formula:

C=Gaussian(m,σ) (3)

In formula (3), C is the color distribution of the hand, Gaussian (m, σ) is the Gaussian function, m is an average color value of the pixels of the position of the hand and the region around the hand, and σ is a variance of the color distribution in the image data D_img.

In another exemplary embodiment, the computing processor 1330 may compare the image intensity information of the image data D_img, e.g. the grayscale information or the chroma information, to a preset color distribution, and define the region satisfying with the preset color distribution in the image data D_img as the hand region. For example, the step of comparing the image intensity information of the image data D_img, to the preset color distribution may be implemented by using the following formula:

|color−m|≦ρ×σ (4)

In formula (4), color is the image intensity information of the image data D_img, m is an average color value of the pixels of the position of the hand and the region around the hand, σ is a variance of the color distribution in the image data D_img, and ρ is an adjustable parameter which is larger than or equal to zero. In one exemplary embodiment, considering that the region of the hand is not separated, the method of breadth-first search (BFS) is accordingly performed to search the hand region from the center point of the hand region when the hand region is searched in the image data D_img. Furthermore, the values of m and σ are updated by the color of the newly searched hand region. In one exemplary embodiment, the RGB of the color are separately calculated, and ρ may be set to 1.5.

In another exemplary embodiment, the computing processor 1330 may identify the hand region by detecting a dynamic motion of the hand, such as waving and the like. For example, the computing processor 1330 may determine whether a variation of the image intensity information of the image data D_img during a preset period exceeds a preset threshold value. When the variation of the image intensity information of a specific region of the image data exceeds the threshold value, the computing processor 1330 defines the region as the hand region.

In still another exemplary embodiment, the computing processor 1330 may detect the position of the hand region by comparing the image intensity information of the image data to a preset image intensity range. The computing processor 1330 defines a region of the image data locating in the image intensity range as the hand region. For example, when the video camera 1320 is a depth detector, the computing processor 1330 defines the region within a certain distance away from the video camera 1320 as the hand region according to a comparison result of the depth data and the preset depth range.

Specifically, in the embodiment that the depth detector is applied to serve as the video camera 1320, in order to avoid the body or the head affecting the detection of the hand region, the depth range may be set based on the depth data of the hand region, such that the computing processor 1330 determines the amount of the variance by calculating an average depth value within the depth range and the variance of the depth value and comparing the average depth value within the depth range and the variance of the depth value to a preset threshold value. For example, when the variance value of the depth data of any region of the image data D_img is smaller than the threshold value, the computing processor 1330 determines the region simply has the hand region. On the contrary, when the variance value of the depth data of any region of the image data D_img is larger than the threshold value, the computing processor 1330 determines the region has the hand region and the body region or the head region. The amount of the variance may be determined based on the following formula:

|D−M|≦p×std (5)

In formula (5), D is the depth data of the image data D_img, M is the average depth value, std is the variance of the depth, and p is an adjustable parameter. When the position of the hand region is obtained, considering the position of the hand locates between the video camera 1320 and the body or the head, the average depth value approaches the value of the hand region, and thus p is set to a positive number, such that the hand region is separated more completely. In one exemplary embodiment, the threshold value of the variance, for example, is 0.6, and p, for example, is 1.

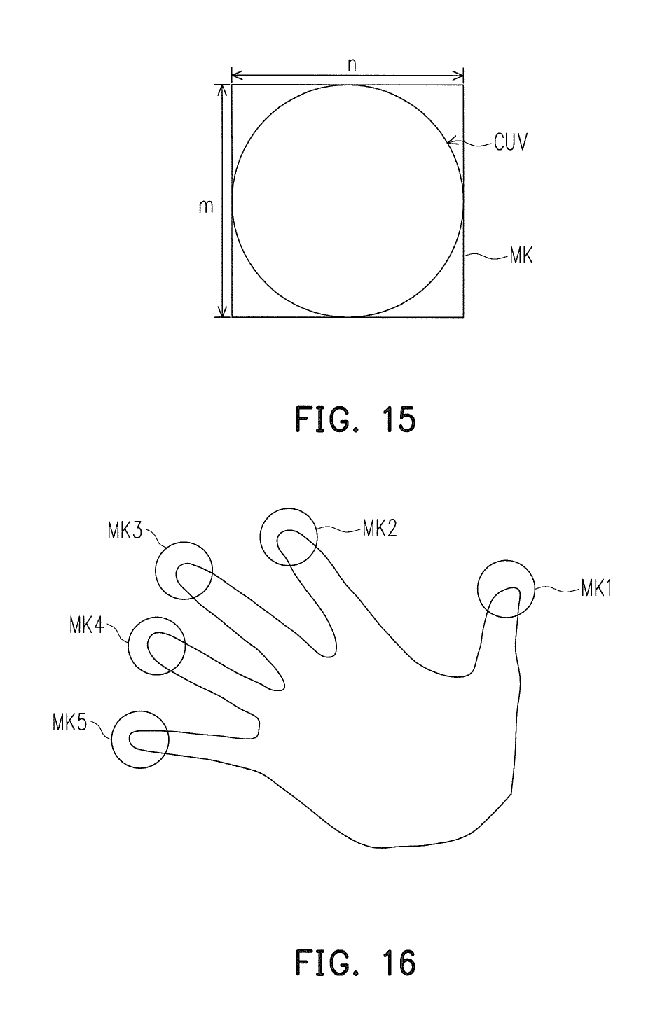

After obtaining the position of the hand region, the computing processor 1330 divides the hand region into a plurality of identification regions and determines whether each of the identification regions satisfies with an identification condition to analyze the finger position of the user, as shown in FIG. 15 and FIG. 16. FIG. 15 and FIG. 16 are schematic diagrams illustrating the detection of the finger position according to an exemplary embodiment of the disclosure.

Referring to FIG. 15 and FIG. 16, the computing processor 1330 divides the hand region into a plurality of identification regions by a mask MK having the size m×n as shown in FIG. 15. Herein, the values m and n may be determined based on the size of the finger. The mask MK comprises a closed curve CUV. The computing processor 1330 may compare the area of the hand region of each of the identification regions and determine whether the overlap length of the hand region the closed curve CUV satisfies with a preset identification condition, so as to determine whether the hand region surrounded by the corresponding mask is the finger position.

To be specific, after the hand region is divided into a plurality of identification regions by a plurality of masks MK each having the size m X n, the computing processor 1330 determines whether each of the identification regions comprises the finger position based on the following identification conditions:

Tₘᵢₙ≦Area≦Tₘₐₓ (6)

Periphery≦T_{Periphery} (7)

wherein Area is the area of the hand region within the identification region. The actual area of the hand region within the identification region is calculated based on the depth data of each hand region and the data point of each hand region. Tmin and Tmax are respectively the minimum threshold value and the maximum threshold value of the area of the hand region. That is, Tmin is a minimum threshold area, and Tmax is a maximum threshold area. Periphery is the overlap length of the closed curve of the mask MK and the hand region. The actual overlap length of the closed curve and the hand region is obtained by the calculation with the depth data. Tperiphery is the overlap threshold length of the closed curve and the hand region, i.e. a length threshold value.

Accordingly, the computing processor 1330 may determine a part of the identification regions that the area of the hand region satisfies with the identification condition (6). Herein, for the determined identification regions, the area of the hand region corresponding thereto satisfies with the preset the finger area. Next, the computing processor 1330 further analyzes the finger position based on the identification regions satisfying with the identification condition (7). Herein, for the determined identification regions, the shape of the hand region corresponding thereto satisfies with characteristics of the peripheral region, as shown in FIG. 16. Based on the above analysis and comparison method, the computing processor 1330 may detect that the finger position locates within the identification regions formed by the masks MK1 to MK5.

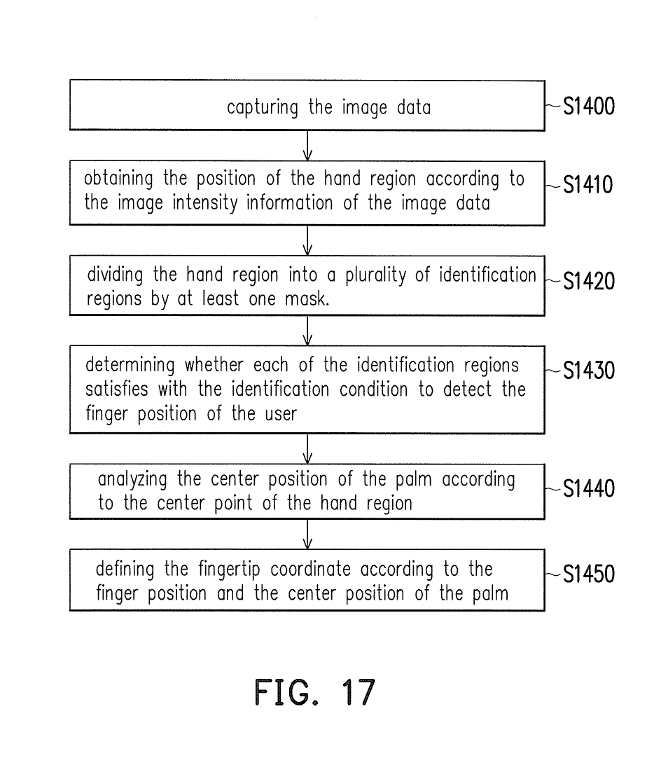

FIG. 17 is a flow chart illustrating the method for detecting the finger position according to another exemplary embodiment of the disclosure. In the present embodiment, the steps S1400 to S1430 are similar to that of the embodiment of FIG. 14, and it will not be described again herein. Referring to FIG. 13 and FIG. 17, after detecting the finger position of the user, the computing processor 1330 further analyzes a center position of a palm according to a center point of the hand region (step S1440), and precisely defines a fingertip coordinate according to the detected finger position and the center position of the palm (step S1450).

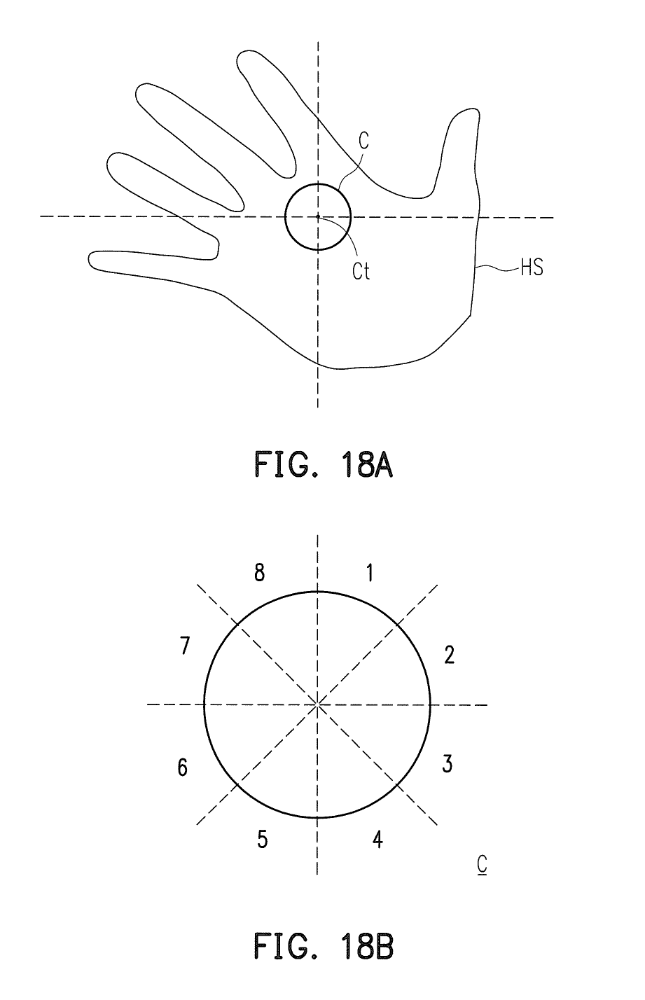

FIG. 18A and FIG. 18B are schematic diagrams illustrating the method for analyzing the center position of the palm according to an exemplary embodiment of the disclosure. Referring to FIG. 18A, in step S1440, the computing processor 1330 defines an adjustable comparison circle C within the detected hand region. Herein, a center position of the comparison circle C is preset on the center point Ct of the hand region.

Specifically, in step S1440, the computing processor 1330 defines the adjustable comparison circle C within the detected hand region. Herein, the center position of the comparison circle C is preset on the center point Ct of the hand region. Next, the computing processor 1330 gradually adjusts a diameter and the center position of the comparison circle C, such that the comparison circle C is adjusted to a maximum inscribed circle which is inscribed in a hand outline HS.

For example, after obtaining the position of the hand region, the computing processor 1330 starts from the center point Ct of the hand region and performs the analysis from a smaller circle. In one exemplary embodiment, the diameter of the comparison circle C may be preset to the size of 31 pixels. Herein, the computing processor 1330 sets the overlap position of the circumference of the comparison circle C and the hand region to 1 and sets the non-overlap position to 0, so as to perform the calculation. The computing processor 1330 gradually increases the diameter of the comparison circle C based on the principle that the comparison circle C is not broken, i.e. the comparison circle C does not exceed the hand outline HS.

In detail, once the comparison circle C is broken, i.e. the comparison circle C exceeds the hand outline HS, the computing processor 1330 adjusts the center position of the comparison circle C first, as shown FIG. 18B. Herein, the circumference of the comparison circle C, for example, is divided into eight orientation sections in FIG. 18B for checking which section has most serious damage, such that the computing processor 1330 moves the center position of the comparison circle C towards an opposite direction. For example, if the section 1 has most serious damage, the comparison circle C is moved towards the direction 5. After the comparison circle C is moved, if the circumference of the comparison circle C is complete, the diameter of the comparison circle C is continuously increased. As a result, the diameter of the comparison circle C is continuously increased, and the center position of the comparison circle C is continuously moved until the comparison circle C is also broken in an opposite direction in a certain movement. In the meanwhile, the computing processor 1330 determines the previous complete comparison circle C is the maximum inscribed circle, and defines the center position of the comparison circle C as the center position of the palm.

Furthermore, in the process of the interactive operation, the position of the hand may continuously move, and the shape of the palm may also continuously change. In other words, during different frames, the area of the palm may be different. Accordingly, in the present embodiment, after the computing processor 1330 analyzes the center position of the palm, for the analysis of the center position of the palm of the next frame, the center position of the palm of the previous frame may be preset as the center position of the comparison circle C, and the diameter of the comparison circle C of the previous frame may be preset as the diameter length, such that the analysis time of the computing processor 1330 is reduced.

Moreover, when the area of the palm of the next frame is larger than that of the previous frame, the computing processor 1330 increases the diameter of the comparison circle C and moves the center position of the comparison circle C to find the center position of the palm. On the contrary, when the area of the palm of the next frame is smaller than that of the previous frame, since each section of the comparison circle C has damage under the initial state of the analysis, the computing processor 1330 decreases the diameter of the comparison circle C and moves the center position of the comparison circle C to find the center position of the palm under this condition.

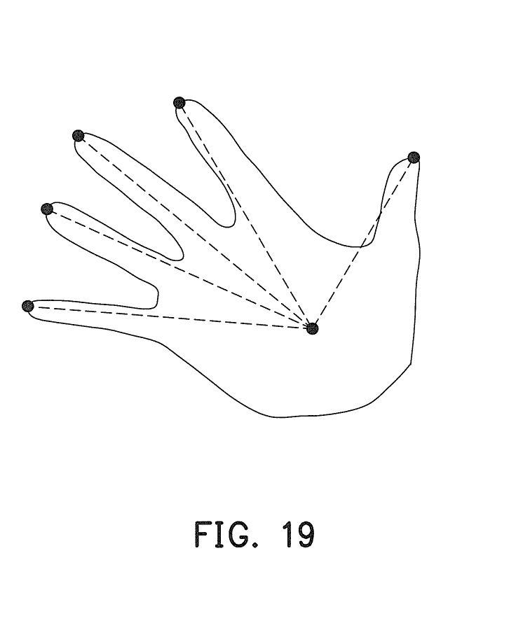

After analyzing the center position of the palm, the computing processor 1330 may determine the furthest coordinate point of the center position of the palm to the finger within each identification region as the fingertip coordinate, as shown in FIG. 19. In FIG. 19, the computing processor 1330 determines the fingertip coordinate based on segments of the center position of the palm and the center points of the detected mask positions MK1 to MK5. The computing processor 1330 analyzes the intersection of the hand region and the background based on the extending direction of the segments. The intersection is the fingertip coordinate of the finger.

In an exemplary embodiment that the display 1310 is a flat panel display, the computing processor 1330 controls the display 1310 to display a cursor of a position corresponding to the palm or the finger of the user in the image on the frame, so as to allow the user realizing the current position of the operation.

Furthermore, in an exemplary embodiment, the computing processor 1330 identifies a gesture action, such as a horizontal movement, a vertical movement, or a stay on the same position, according to the center position of the palm and a movement locus of the identification regions corresponding to the finger position. In addition, the computing processor 1330 identifies the gesture action of the user according to the center position of the palm and the number of the detected identification regions corresponding to the finger position. For example, the computing processor 1330 may identify the gesture action, such as scissors, rock, or paper, according to the center position of the palm and the number of the identification regions.

Moreover, the computing processor 1330 may also identify the grab action of the user based on this method. For example, in one exemplary embodiment, to avoid parts of finger positions in the image being omitted due to the interference of the image noise, the computing processor 1330 may be configured to determine the user opens his/her hand when detecting the user extends more than two fingers, i.e. the release action, and on the contrary, determine the user fists his/her hand, i.e. the grab action.

The image interaction system 1300 of the present embodiment may be the foregoing interactive stereo display system. In other words, the method for detecting the finger position of the present embodiment may be applied to the foregoing stereo display system 100, such that the stereo display system 100 automatically detects the finger position of the user. Accordingly, the user performs the interaction operation on the stereo image by the finger.

In summary, in the stereo display system and the control method of the stereo display provided in the disclosure, by detecting the eyes position of the viewer, the left eye image and the right eye image displayed by the stereo display are adaptively adjusted according to the eyes position, such that the stereo image viewed by the viewer is displayed on the specific position, or a constant distance between the stereo image and the viewer is maintained based on the requirement of the viewer. Furthermore, the method for detecting the finger position and the image interaction system are provided in the disclosure. The hand region is divided into a plurality of identification regions, and whether each of the identification regions satisfies with an identification condition is determined to detect the finger position of the user, such that the operation action of the user is effectively identified in the image interaction system, and thus the operational sensitivity of the image interaction system is further enhanced.

It will be apparent to those skilled in the art that various modifications and variations can be made to the structure of the disclosed embodiments without departing from the scope or spirit of the disclosure. In view of the foregoing, it is intended that the disclosure covers modifications and variations of this disclosure provided they fall within the scope of the following claims and their equivalents.

What is claimed is:

1. A stereo display system comprising:
a stereo display configured to display a left eye image and a right eye image, such that a left eye and a right eye of a viewer generate a parallax to view a stereo image;
a depth detector configured to capture a depth data of a three-dimensional space; and
a computing processor coupled to the stereo display and the depth detector and configured to control image display of the stereo display, wherein the computing processor analyzes an eyes position of the viewer according to the depth data, and when the viewer moves horizontally, vertically, or obliquely in the three-dimensional space relative to the stereo display, the computing processor adjusts the left eye image and the right eye image based on variations of the eyes position.

2. The stereo display system as recited in claim 1, wherein the computing processor computes an appearance position of the stereo image appeared in the three-dimensional space according to the eyes position and a display position of the left eye image and the right eye image displayed in the stereo display.

3. The stereo display system as recited in claim 2, wherein when the viewer moves horizontally or vertically in the three-dimensional space relative to the stereo display, the computing processor adjusts the display position of the left eye image and the right eye image displayed in the stereo display, so as to maintain a constant distance between the appearance position and the eyes position.

4. The stereo display system as recited in claim 2, wherein when the viewer moves horizontally or vertically in the three-dimensional space relative to the stereo display, the computing processor adjusts the display position of the left eye image and the right eye image displayed in the stereo display, so that the appearance position is fixed on a preset position.

5. The stereo display system as recited in claim 2, wherein when the viewer moves obliquely in the three-dimensional space relative to the stereo display, the computing processor adjusts the display position of the left eye image and the right eye image displayed in the stereo display, such that the stereo image faces the eyes position.

6. The stereo display system as recited in claim 2, wherein the computing processor defines coordinates of a first vector, a second vector and a third vector in the three-dimensional space, and the computing processor computes a coordinate of the appearance position on the first vector according to the following formula:
$${P}_{z} = \frac{{E}_{z} \times {D}_{obj} \times {W}_{dp}}{{D}_{obj} \times {W}_{dp} + {W}_{eye} \times {R}_{X}}$$
wherein Pz is the coordinate of the appearance position on the first vector, Ez is a coordinate of the left eye position or the right eye position on the first vector, Wdp is a width of a display region of the stereo display, Weye is a distance between the left eye and the right eye, Dobj is a disparity between the left eye image and the right eye image, and Rx is a resolution of the stereo display on the second vector.

7. The stereo display system as recited in claim 6, wherein the computing processor computes the coordinate of the appearance position on the second vector and the third vector according to the follow formula:
$${P}_{x , y} = {E}_{x , y} + \frac{( {O}_{x , y} - {E}_{x , y} ) \times ( {E}_{z} - {P}_{z} )}{{E}_{z}}$$
wherein Px,y is the coordinate of the appearance position on the second vector and the third vector, Ex,y is a coordinate of the left eye position or the right eye position on the second vector and the third vector, Ox,y is a coordinate of the left eye image or the right eye image on the second vector and the third vector, wherein Ox,y is corresponding to the left eye image when Ex,y and Ez are corresponding to the left eye position, and Ox,y is corresponding to the right eye image when Ex,y and Ez are corresponding to the right eye position.

8. The stereo display system as recited in claim 1, wherein when a disparity between the left eye image and the right eye image is set to a target value, the stereo display gradually increases the disparity between the left eye image and the right eye image to the target value during an initial display period.

9. The stereo display system as recited in claim 1, wherein the computing processor analyzes the depth data within a preset region to obtain the eyes position.

10. The stereo display system as recited in claim 1, wherein the computing processor detects a dynamic motion to select a locating region corresponding to the dynamic motion, and the computing processor analyzes the depth data within the locating region to obtain the eyes position.

11. The stereo display system as recited in claim 1, wherein the computing processor detects a static posture to select a locating region corresponding to the static posture, and the computing processor analyzes the depth data within the locating region to obtain the eyes position.

12. The stereo display system as recited in claim 1, wherein the computing processor is further configured to detect a touch event and control image display of the stereo display according to the touch event.

13. The stereo display system as recited in claim 12, wherein the computing processor compares an appearance position of the stereo image appeared in the three-dimensional space with a position of a touch media to determine whether the appearance position overlaps with the position of the touch media, and when the appearance position overlaps with the position of the touch media, the computing processor deter lines the touch event occurs.

14. The stereo display system as recited in claim 13, wherein when the appearance position overlapping with the position of the touch media is determined, and the touch media stays in a movement status, the computing processor continuously detects a movement locus of the touch media according to the depth data, and the computing processor controls the stereo display according to the movement locus.

15. The stereo display system as recited in claim 13, wherein the computing processor identifies whether the touch media is a specific touch media, and the computing processor determines the touch event does not occur when the stereo image is not touched by the specific touch media.

16. The stereo display system as recited in claim 15, wherein the computing processor compares the touch media with at least one preset template to identify whether the touch media is the specific touch media.

17. The stereo display system as recited in claim 15, wherein the computing processor compares the touch media with at least one dynamic motion to identify whether the touch media is the specific touch media.

18. The stereo display system as recited in claim 15, wherein when the specific touch media is at least one finger, the computing processor analyzes a position of the at least one finger according to a hand outline.

19. The stereo display system as recited in claim 15, wherein when the specific touch media is at least one finger, the computing processor divides a position of a hand into a plurality of identification regions and compares the depth data of the identification regions with an identification condition to analyze a position of the at least one finger.

20. The stereo display system as recited in claim 12, wherein the stereo display system is an interactive stereo display system.

21. A control method of a stereo display comprising:
displaying a left eye image and a right eye image, such that a left eye and a right eye of a viewer generate a parallax to view a stereo image;
capturing a depth data of a three-dimensional space;
analyzing an eyes position of the viewer according to the depth data; and
adjusting the left eye image and the right eye image based on variations of the eyes position when the viewer moves horizontally, vertically, or obliquely in the three-dimensional space relative to the stereo display.

22. The control method of the stereo display recited in claim 21, wherein the step of displaying the left eye image and the right eye image comprises:
gradually increasing a disparity between the left eye image and the right eye image to a target value during an initial display period when the disparity between the left eye image and the right eye image is set to the target value.

23. The control method of the stereo display recited in claim 21, wherein the step of analyzing the eyes position of the viewer according to the depth data comprises:
analyzing the depth data within a preset region to obtain the eyes position.

24. The control method of the stereo display recited in claim 21, wherein the step of analyzing the eyes position of the viewer according to the depth data comprises:
detecting a dynamic motion;
selecting a locating region corresponding to the dynamic motion; and
analyzing the depth data within the locating region to obtain the eyes position.

25. The control method of the stereo display recited in claim 21, wherein the step of analyzing the eyes position of the viewer according to the depth data comprises:
detecting a static posture;
selecting a locating region corresponding to the static posture; and
analyzing the depth data within the locating region to obtain the eyes position.

26. The control method of the stereo display recited in claim 21, wherein the step of adjusting the left eye image and the right eye image based on the variations of the eyes position comprises:
computing an appearance position of the stereo image appeared in the three-dimensional space according to the eyes position and a display position of the left eye image and the right eye image displayed in the stereo display.

27. The control method of the stereo display recited in claim 26, wherein the step of adjusting the left eye image and the right eye image based on the variations of the eyes position when the viewer moves horizontally or vertically in the three-dimensional space relative to the stereo display further comprises:
adjusting the display position of the left eye image and the right eye image displayed in the stereo display, so as to maintain a constant distance between the appearance position and the eyes position.

28. The control method of the stereo display recited in claim 26, wherein the step of adjusting the left eye image and the right eye image coordinating with variations of the eyes position when the viewer moves horizontally or vertically in the three-dimensional space relative to the stereo display further comprises:
adjusting the display position of the left eye image and the right eye image displayed in the stereo display, so that the appearance position is fixed on a preset position.

29. The control method of the stereo display recited in claim 26, wherein the step of adjusting the left eye image and the right eye image based on the variations of the eyes position when the viewer moves obliquely in the three-dimensional space relative to the stereo display further comprises:
adjusting the display position of the left eye image and the right eye image displayed in the stereo display, such that the stereo image faces the eyes position.

30. The control method of the stereo display recited in claim 26, wherein the step of computing the appearance position of the stereo image appeared in the three-dimensional space comprises:
defining coordinates of a first vector, a second vector and a third vector in the three-dimensional space;
computing a coordinate of the appearance position on the first vector according to the following formula:
$${P}_{z} = \frac{{E}_{z} \times {D}_{obj} \times {W}_{dp}}{{D}_{obj} \times {W}_{dp} + {W}_{eye} \times {R}_{X}}$$
wherein Pz is the coordinate of the appearance position on the first vector, Ez is a coordinate of the left eye position or the right eye position on the first vector, Wdp is a width of a display region of the stereo display, Weye is a distance between the left eye and the right eye, Dobj is a disparity between the left eye image and the right eye image, and Rx is a resolution of the stereo display on the second vector; and
computing the coordinate of the appearance position on the second vector and the third vector according to the follow formula:
$${P}_{x , y} = {E}_{x , y} + \frac{( {O}_{x , y} - {E}_{x , y} ) \times ( {E}_{z} - {P}_{z} )}{{E}_{z}}$$
wherein Px,y is the coordinate of the appearance position on the second vector and the third vector, Ex,y is a coordinate of the left eye position or the right eye position on the second vector and the third vector, Ox,y is a coordinate of the left eye image or the right eye image on the second vector and the third vector, wherein Ox,y is corresponding to the left eye image when Ex,y and Ez are corresponding to the left eye position, and Ox,y is corresponding to the right eye image when Ex,y and Ez are corresponding to the right eye position.

31. The control method of the stereo display recited in claim 21, wherein after the step of adjusting the left eye image and the right eye image based on the variations of the eyes position, the control method further comprises:
detecting a touch event; and
controlling image display of the stereo display according to the touch event.

32. The control method of the stereo display recited in claim 31, wherein the step of detecting the touch event comprises:
comparing an appearance position of the stereo image appeared in the three-dimensional space with a position of a touch media;
determining whether the appearance position overlaps with the position of the touch media; and
determining the touch event occurs when the appearance position overlaps with the position of the touch media.

33. The control method of the stereo display recited in claim 32, wherein when the appearance position overlaps with the position of the touch media, the step of detecting the touch event further comprises:
detecting a movement locus of the touch media continuously according to the depth data; and
controlling image display of the stereo display according to the movement locus.

34. The control method of the stereo display recited in claim 32 wherein the step of detecting the touch event further comprises:
identifying whether the touch media is a specific touch media; and
determining the touch event does not occur when the stereo image is not touched by the specific touch media.

35. The control method of the stereo display recited in claim 34, wherein the step of identifying whether the touch media is a specific touch media comprises:
comparing the touch media with at least one preset template to identify whether the touch media is the specific touch media.

36. The control method of the stereo display recited in claim 34, wherein the step of identifying whether the touch media is a specific touch media comprises:
comparing the touch media with at least one dynamic motion to identify whether the touch media is the specific touch media.

37. The control method of the stereo display recited in claim 34, wherein when the specific touch media is at least one finger, the step of detecting the touch event further comprises:
analyzing a position of the at least one finger according to a hand outline.

38. A stereo display system comprising:
a stereo display configured to display a left eye image and a right eye image, such that a left eye and a right eye of a viewer generate a parallax to view a stereo image;
a depth detector configured to capture a depth data of a three-dimensional space; and
a computing processor coupled to the stereo display and the depth detector and configured to control image display of the stereo display, wherein the computing processor analyzes an eyes position of the viewer according to the depth data and computes an appearance position of the stereo image appeared in the three-dimensional space according to the eyes position and a display position of the left eye image and the right eye image displayed in the stereo display,
wherein the computing processor performs the following steps:
defining coordinates of a first vector, a second vector and a third vector in the three-dimensional space;
computing a coordinate of the appearance position on the first vector according to a formula of
$${P}_{z} = \frac{{E}_{z} \times {D}_{obj} \times {W}_{dp}}{{D}_{obj} \times {W}_{dp} + {W}_{eye} \times {R}_{X}} ;$$
and
computing the coordinate of the appearance position on the second vector and the third vector according to a formula of
$${P}_{x , y} = {E}_{x , y} + \frac{( {O}_{x , y} - {E}_{x , y} ) \times ( {E}_{z} - {P}_{z} )}{{E}_{z}} ,$$
wherein Pz is the coordinate of the appearance position on the first vector, Px,y is the coordinate of the appearance position on the second vector and the third vector, Ez is a coordinate of the left eye position or the right eye position on the first vector, Ex,y is a coordinate of the left eye position or the right eye position on the second vector and the third vector, Wdp is a width of a display region of the stereo display, Ox,y is a coordinate value of the left eye image or the right eye image on the second vector and the third vector, Weye is a distance between the left eye and the right eye, Dobj is a disparity between the left eye image and the right eye image, and Rx is a resolution of the stereo display on the second vector,
wherein Ox,y is corresponding to the left eye image when Ex,y and Ez are corresponding to the left eye position, and Ox,y is corresponding to the right eye image when Ex,y and Ez are corresponding to the right eye position,
wherein the computing processor adjusts the left eye image and the right eye image based on variations of the eyes position when the viewer moves in the three-dimensional space.

39. The stereo display system as recited in claim 38, wherein the computing processor adjusts the display position of the left eye image and the right eye image displayed in the stereo display, so as to maintain a constant distance between the appearance position and the eyes position.

40. The stereo display system as recited in claim 38, wherein the computing processor adjusts the display position of the left eye image and the right eye image displayed in the stereo display when the viewer moves horizontally or vertically in the three-dimensional space relative to the stereo display, such that the appearance position is fixed on a preset position.

41. The stereo display system as recited in claim 38, wherein the computing processor adjusts the display position of the left eye image and the right eye image displayed in the stereo display when the viewer moves obliquely in the three-dimensional space relative to the stereo display, such that the stereo image faces the eyes position.

42. A method for detecting a finger position, adapted to detect the finger position of a user, the method comprising:
capturing an image data;
obtaining a position of a hand region according to an image intensity information of the image data;
dividing the hand region into a plurality of identification regions by at least one mask; and
determining whether the identification regions satisfy with an identification condition to detect the finger position of the user.

43. The method for detecting the finger position as recited in claim 42, wherein the step of obtaining the position of the hand region according to the image intensity information of the image data comprises:
setting a threshold value;
determining whether a variation of the image intensity information of the image data during a preset period exceeds the threshold value; and
defining a region of the image data corresponding to the variation of the image intensity information exceeding the threshold value as the hand region.

44. The method for detecting the finger position as recited in claim 42, wherein the step of obtaining the position of the hand region according to the image intensity information of the image data comprises:
setting an image intensity range; and
comparing the image intensity information of the image data to the image intensity range, and defining a region of the image data locating in the image intensity range as the hand region.

45. The method for detecting the finger position as recited in claim 42, wherein the step of obtaining the position of the hand region according to the image intensity information of the image data comprises:
calculating an average value and a variance of the image intensity information based on the image data; and
defining the hand region according to a calculation result.

46. The method for detecting the finger position as recited in claim 42, wherein the step of determining whether the identification regions satisfy with the identification condition to detect the finger position of the user comprises:
determining whether an area of the hand region within each of the identification regions is larger than or equal to a minimum threshold area and smaller than or equal to a maximum threshold area;
when the area of the hand region within one of the identification regions is larger than or equal to the minimum threshold area and smaller than or equal to the maximum threshold area, determining the one of the identification regions satisfies with a first identification condition;
determining whether an overlap length of the hand region within each of the identification regions and a closed curve of the least one mask smaller than or equal to a length threshold value;
when the overlap length of the hand region within one of the identification regions and the closed curve of the least one mask smaller than or equal to the length threshold value, determining the one of the identification regions satisfies with a second identification condition;
determining whether the area of the hand region within each of the identification regions satisfies with the first identification condition;
determining whether the overlap length of the hand region within each of the identification regions and the closed curve of the least one mask satisfies with the second identification condition; and
defining the hand regions within the identification regions simultaneously satisfying with the first identification condition and the second identification condition as the finger position.

47. The method for detecting the finger position as recited in claim 42, further comprising:
analyzing a center position of a palm according to a center point of the hand region; and
defining a fingertip coordinate according to the finger position and the center position of the palm.

48. The method for detecting the finger position as recited in claim 47, wherein the step of analyzing the center position of the palm according to the center point of the hand region comprises:
defining a comparison circle, wherein a center position of the comparison circle is preset on the center point of the hand region;
gradually adjusting a diameter and the center position of the comparison circle, such that the comparison circle is adjusted to a maximum inscribed circle which is inscribed in a hand outline; and
when the comparison circle is adjusted to the maximum inscribed circle in the hand outline, defining the center position of the comparison circle as the center position of the palm.

49. The method for detecting the finger position as recited in claim 47, further comprising:
identifying a gesture action of the user according to the center position of the palm and the number of the identification regions corresponding to the finger position.

50. The method for detecting the finger position as recited in claim 47, further comprising:
identifying a gesture action of the user according to the center position of the palm and a movement locus of the identification regions corresponding to the finger position.

51. An image interaction system, comprising:
a display configured to display an interactive image;
a video camera configured to capture an image of a user to generate an image data; and
a computing processor coupled to the display and the video camera and configured to control frame display of the display,
wherein the computing processor obtains a position of a hand region according to an image intensity information of the image data captured by the video camera, divides the hand region into a plurality of identification regions by at least one mask, and determines whether the identification regions satisfy with an identification condition to detect the finger position of the user.

52. The image interaction system as recited in claim 51, wherein the computing processor compares the image intensity information of the image data to an image intensity range, and defines a region of the image data locating in the image intensity range as the hand region.

53. The image interaction system as recited in claim 51, wherein the computing processor calculates an image intensity distribution according to the image intensity information of the image data, compares the image intensity distribution to a hand image intensity information range, and defines a region of the image data locating in hand image intensity information range as the hand region.

54. The image interaction system as recited in claim 51, wherein the computing processor determines whether a variation of the image intensity information of the image data during a preset period exceeds a threshold value, and defines a region of the image data corresponding to the variation of the image intensity information exceeding the threshold value as the hand region.

55. The image interaction system as recited in claim 51, wherein the computing processor determines whether an area of the hand region within each of the identification regions is larger than or equal to a minimum threshold area and smaller than or equal to a maximum threshold area, and when the area of the hand region within one of the identification regions is larger than or equal to the minimum threshold area and smaller than or equal to the maximum threshold area, the computing processor determines the one of the identification regions satisfies with a first identification condition,
wherein the computing processor determines whether an overlap length of the hand region within each of the identification regions and a closed curve of the least one mask smaller than or equal to a length threshold value, and when the overlap length of the hand region within one of the identification regions and the closed curve of the least one mask smaller than or equal to the length threshold value, the computing processor determines the one of the identification regions satisfies with a second identification condition,
wherein the computing processor determines whether the area of the hand region within each of the identification regions satisfies with the first identification condition, and determines whether the overlap length of the hand region within each of the identification regions and the closed curve of the least one mask satisfies with the second identification condition, wherein the computing processor defines the hand regions within the identification regions simultaneously satisfying with the first identification condition and the second identification condition as the finger position.

56. The image interaction system as recited in claim 51, wherein the computing processor further analyzes a center position of a palm according to a center point of the hand region, and defines a fingertip coordinate according to the finger position and the center position of the palm.

57. The image interaction system as recited in claim 56, wherein the computing processor defines a comparison circle that a center position is preset on the center point of the hand region, and gradually adjusts a diameter and the center position of the comparison circle, such that the comparison circle is adjusted to a maximum inscribed circle which is inscribed in a hand outline, wherein when the comparison circle is adjusted to the maximum inscribed circle in the hand outline, the computing processor defines the center position of the comparison circle as the center position of the palm.

58. The image interaction system as recited in claim 56, wherein the computing processor identifies a gesture action of the user according to the center position of the palm and the number of the identification regions corresponding to the finger position.

59. The image interaction system as recited in claim 56, wherein the computing processor identifies a gesture action of the user according to the center position of the palm and a movement locus of the identification regions corresponding to the finger position.

60. The image interaction system as recited in claim 51, wherein the video camera is a depth detector and the display is a stereo display, the image data captured by the depth detector comprises a depth data, the stereo display is configured to display a left eye image and a right eye image, such that a left eye and a right eye of a viewer generate a parallax to view a stereo image,
wherein the computing processor analyzes an eyes position of the viewer according to the depth data, and when the viewer moves horizontally, vertically, or obliquely in the three-dimensional space relative to the stereo display, the computing processor adjusts the left eye image and the right eye image based on variations of the eyes position.
